(19) United States
(12) Patent Application Publication
(10) Pub. No.: US 2026/0119790 A1
(43) Pub. Date: Apr. 30, 2026

(54) AUTOMATIC DOCUMENT ANALYSIS AND MODIFICATION SYSTEMS AND APPLICATIONS

(71) Applicant: NVIDIA Corporation, Santa Clara, CA (US)

(72) Inventors: Brian David McBrayer, Fuquay-Varina, NC (US); Yuliana Yajaira Zamora, Naperville, IL (US); Suchismita Sahu, San Jose, CA (US)

(21) Appl. No.: 18/930,626

(22) Filed: Oct. 29, 2024

(51) Int. Cl. G06F 40/186; G06F 40/194

(52) U.S. Cl. CPC G06F 40/186; G06F 40/194

(57) ABSTRACT

In various examples, automatic document analysis and modification systems and applications are described herein. Systems and methods are disclosed that automatically identify clauses that potentially need updating in documents—such as templates—using one or more language models. Systems and methods are further disclosed that provide information associated with updating the identified documents to users. For instance, user interfaces are provided that allow users to view at least the clauses that potentially need updating, reasons the clauses potentially need updating, techniques for updating the clauses, and/or text showing the clauses as updated. Systems and methods are then further disclosed that use the language model(s) to automatically update the clauses in the documents. For instance, once the updates are verified, the language model(s) may process input data associated with the documents and the updated clauses in order to apply the updates to the documents.

### BACKGROUND

Documents—such as templates of contracts, agreements, licenses, memos, and/or the like—may be created using clauses that are stored in one or more libraries. For example, legal documents may include clauses describing or drafted in view of current laws, rulings, regulations, standards, compliances, and/or requirements, where the language in the clauses is standard across the legal profession and/or standard internally to an entity (e.g., a corporation, a company, a business, an organization, a firm, etc.). However, in some circumstances, one or more of the clauses may be updated, such as by deleting text, updating text, and/or adding text. For example, the clauses in the legal documents may be updated when the laws, the policies, the rulings, the regulations, the standards, the compliances, and/or the requirements change. When a clause is updated, each document that includes the clause may also need updating in order to replace the older version of the clause with the updated, current version of the clause.

Conventional systems that update documents require a large amount of user interaction. For example, the conventional systems may require users to view the updated clauses, search through a number of documents that potentially need updating using the updated clauses, select the documents that need updating, and then replace the clauses within the selected documents. However, requiring users to perform such processes may be time consuming based on the number of documents and/or clauses that need to be searched. For example, an entity may store hundreds and/or thousands of documents that potentially use hundreds and/or thousands of clauses. Additionally, requiring users to perform such processes may be prone to error, such as users missing clauses that need to be updated in documents and/or updating clauses that should not have been updated. In some examples, these errors may cause additional problems, such as when legal documents are not updated with the most current laws and/or regulations.

As such, other conventional systems may use machine learning models to analyze documents in order to identify errors. For examples, these conventional systems may analyze a legal document in order to identify terms within the legal document that should be updated and/or to update language within the legal documents based on similar legal documents for which the machine learning models have been trained. However, these conventional systems are only able to analyze a single document at a time. Additionally, these conventional systems are unable to identify clauses within documents that should be updated—such as when the clauses are updated in a clause's library.

### SUMMARY

Embodiments of the present disclosure relate to automatic document analysis and modification systems and applications. Systems and methods are disclosed that automatically identify clauses that potentially need updating in documents—such as templates—using one or more models—such as one or more language models (and/or any other type of model). For instance, the model(s) may process input data associated with the documents and a library of clauses in order to identify the clauses within the documents that potentially need updating and/or determine suggestions for updating the clauses. Systems and methods are further disclosed that provide information associated with updating the identified documents to users. For instance, one or more user interfaces are provided that allow users to view at least the clauses that potentially need updating, reasons the clauses potentially need updating, the suggestions for updating the clauses, and/or text showing the clauses as updated. Systems and methods are then further disclosed that use the model(s) to automatically update the clauses in the documents. For instance, the users may use the user interface(s) to verify the suggested updates and/or add additional updates before verification. Once verified, the model(s) may process input data associated with the documents and the suggested updates in order to apply the updates to the documents.

In contrast to conventional systems, such as those that require solely user interaction for carrying updates through various documents/templates, the systems of the present disclosure, in some embodiments, use the model(s) to automatically identify clauses in documents that potentially need to be updated and/or update the identified clauses in the documents. This may save human resources, as users do not have to search through and/or update hundreds and/or thousands of documents each time a clause is updated, and may reduce errors when updating documents, since—when not performed automatically by the system—users merely have to view and/or approve suggested updates that are provided by the model(s). Additionally, in contrast to the conventional systems that analyze documents using machine learning models, the systems of the present disclosure are able to automatically identify clauses from a library that potentially need updating, determine and/or provide suggestions for updating the clauses, receive user feedback for additional updating suggestions, and then automatically update the clauses within the documents using the suggested updates.

### BRIEF DESCRIPTION OF THE DRAWINGS

The present systems and methods for automatic document analysis and modification systems and applications are described in detail below with reference to the attached drawing figures, wherein:

FIG. 1A illustrates an example of a process for analyzing documents to identify and provide information associated with potential clause updates, in accordance with some embodiments of the present disclosure;

FIG. 1B illustrates an example of a process for updating clauses within documents, in accordance with some embodiments of the present disclosure;

FIG. 1C illustrates an example of a process for training one or more language models using user feedback, in accordance with some embodiments of the present disclosure;

FIG. 2 illustrates an example of a process for identifying clauses within documents that potentially need updating, in accordance with some embodiments of the present disclosure;

FIG. 3 illustrates an example of a process for extracting clauses from documents, in accordance with some embodiments of the present disclosure;

FIG. 4 illustrates an example of a process for verifying clauses from documents that potentially need to be updated, in accordance with some embodiments of the present disclosure;

FIG. 5 illustrates an example of a process for determining information for updating clauses included in documents, in accordance with some embodiments of the present disclosure;

FIGS. 6A-6D illustrate examples of user interfaces that provide information associated with potential clause updates for documents, in accordance with some embodiments of the present disclosure;

FIG. 7A illustrates an example of receiving user feedback to update a suggested clause for a document, in accordance with some embodiments of the present disclosure;

FIG. 7B illustrates an example of receiving user feedback to update a verified clause within a document, in accordance with some embodiments of the present disclosure;

FIG. 8 illustrates an example of a process for extracting clauses when updating documents, in accordance with some embodiments of the present disclosure;

FIG. 9A illustrates an example of a process for updating clauses of documents, in accordance with some embodiments of the present disclosure;

FIG. 9B illustrates an example of updating a clause within a document with a user suggested clause, in accordance with some embodiments of the present disclosure;

FIG. 10A illustrates an example of a user interface that provides information for verifying an updated document, in accordance with some embodiments of the present disclosure;

FIG. 10B illustrates an example of a process for verifying an updated document, in accordance with some embodiments of the present disclosure;

FIG. 11 illustrates an example of one or more systems that may perform at least a portion of the processes described herein, in accordance with some embodiments of the present disclosure;

FIG. 12 illustrates a flow diagram showing a method for identifying and updating a clause within a document, in accordance with some embodiments of the present disclosure;

FIG. 13 illustrates a flow diagram showing a method for analyzing documents to identify information for updating clauses in the documents, in accordance with some embodiments of the present disclosure;

FIG. 14A is a block diagram of an example generative language model system suitable for use in implementing at least some embodiments of the present disclosure;

FIG. 14B is a block diagram of an example generative language model that includes a transformer encoder-decoder suitable for use in implementing at least some embodiments of the present disclosure;

FIG. 14C is a block diagram of an example generative language model that includes a decoder-only transformer architecture suitable for use in implementing at least some embodiments of the present disclosure;

FIG. 15 is a block diagram of an example computing device suitable for use in implementing at least some embodiments of the present disclosure; and

FIG. 16 is a block diagram of an example data center suitable for use in implementing at least some embodiments of the present disclosure.

### DETAILED DESCRIPTION

Systems and methods are disclosed related to automatic document analysis and modification systems and applications. For instance, a system(s) may generate, receive, retrieve, obtain, and/or store data representing documents—such as memos, contracts, agreements, licenses, instructions, manuals, lists, forms, charts, and/or any other type of document. In some examples, at least a portion of the documents may include template documents, where a template document is created using one or more clauses stored in a clause's library (and/or other storage mechanism). For example, if a template is created for a legal document, then the template may include one or more clauses related to laws, rulings, regulations, standards, policies, compliances, and/or requirements that are standard across the legal profession and/or specific to an entity.

In some circumstances, at least a portion of the clauses stored in the clause's library may be updated from previous versions of the clauses to current versions of the clauses. For example, if the clause's library includes legal clauses, then one or more of the clauses may be updated when laws, rulings, compliances, regulations, standards, policies, and/or requirements are changed, modified, updated, and/or created. As described herein, updating a clause may include deleting text from the clause, changing text included in the clause, adding text to the clause, updating formatting associated with the clause, updating definitions for one or more terms included in the clause, and/or performing any other type of update associated with the clause. When clauses within the clause's library are updated, it may be important to update the corresponding clauses as included in the documents such that the documents represent the most current information.

As such, the system(s) may process at least a portion of the documents and at least a portion of the clauses from the clause's library (also referred to as “analyzed clauses” or “boilerplate clauses”) using one or more models, such as one or more language models (and/or any other type of model). For example, and for a respective clause, the system(s) may input data (e.g., tokens, embeddings, etc.) associated with at least the clause, the documents, and/or a prompt into the model(s). In some examples, the prompt may be associated with instructing the model(s) to perform a task, such as to identify the clause (e.g., a previous version of the clause, a current version of the clause, a modified version of the clause, etc.) within the documents. The model(s) may process the input data and, based at least on the processing, generate and/or output data indicating one or more documents that potentially include the clause and/or one or more portions of text within the document(s) that correspond to the clause. Additionally, in some examples, the model(s) (and/or another model(s)) may extract the clause(s) from the document(s). For instance, the model(s) (and/or the other model(s)) may be provided with an additional prompt that is associated with extracting the text corresponding to the clause(s).

In some examples, the system(s) may perform one or more additional processes in order to verify that the clauses extracted from the documents are associated with the analyzed clauses from the clause's library. For instance, the system(s) may input data (e.g., tokens, embeddings, etc.) associated with an extracted clause, an analyzed clause, and/or a prompt into the model(s) (and/or one or more other models). In some examples, the prompt may be associated with instructing the model(s) to perform a task, such as to verify that the clauses are related. The model(s) may then process the input data and, based at least on the processing, generate and/or output data indicating whether the extracted clause is related to analyzed clause. As described here, the extracted clause may be related to the analyzed clause when the extracted clause includes a previous version of the analyzed clause, a current version of the analyzed clause, and/or a modified version of the analyzed clause.

In some examples, the system(s) may perform one or more additional processes to determine information associated with updating clauses (the “identified and/or extracted clauses”) within the documents. For instance, the system(s) may input data (e.g., tokens, embedding, etc.) associated with an identified clause (and/or a document that includes the identified clause), an analyzed clause that is related to the identified clause, and/or a prompt into the model(s) (and/or one or more other models). In some examples, the prompt may be associated with instructing the model(s) to perform a task, such as to determine one or more updates that should occur with regard to the identified clause from the document. The model(s) may then process the input data and, based at least on the processing, generate and/or output data representing information associated with updating the identified clause. As described herein, the information may include, but is not limited to, differences between the clauses, suggested updates to perform on the identified clause, text representing the identified clause as updated with the suggested updates, and/or any other update information.

The system(s) may provide information associated with the analysis of the documents to one or more users for review. For instance, the system(s) may generate one or more user interfaces that include information indicating documents that potentially need updating, identified clauses within the documents that potentially need updating, differences between the identified clauses that potentially needed updating and the analyzed clauses from the clause's library, suggested updates for the identified clauses, text representing the identified clauses as updated based on the suggestions (also referred to as “suggested clauses”), and/or any other information associated with the analysis. The system(s) may then cause one or more client devices to provide the user interface(s) to the user(s). This way, the user(s) is able to quickly and efficiently determine which documents and/or clauses may potentially need updating and/or how to update the documents and/or clauses.

In some examples, the system(s) may receive feedback from the user(s) with regard to the analysis of the documents. For a first example, the system(s) may receive feedback indicating whether identified clauses do in fact need updating, such as when the identified clauses differ from the current clauses from the clause's library, and/or whether the identified clauses do not need updating, such as when the identified clauses do not differ from the current clauses and/or are not in fact related to the analyzed clauses used for the identification. For a second example, the system(s) may receive feedback indicating one or more additional clauses in the documents to analyze for potential updating. Still, for a third example, if an identified clause needs updating, the system(s) may receive feedback representing one or more additional updates to the clause beyond the initial suggested updates determined using the model(s). For instance, a user may remove text, update text, and/or add text associated with a suggested update for the identified clause.

The system(s) may also update one or more of the identified clauses within one or more documents. For instance, the system(s) may determine to update an identified clause within a document, such as based on user feedback instructing the system(s) to update the identified clause and/or automatically. The system(s) may then perform one or more processes to update the identified clause within the document using the suggested clause provided to the user(s). In some examples, to update the identified clause, the system(s) may input data (e.g., tokens, embeddings, etc.) associated with at least the document that includes the identified clause, the suggested clause, and/or a prompt into the model(s). In some examples, the prompt may be associated with instructing the model(s) to perform a task, such as to replace and/or update the identified clause within the document based on the suggested clause. The model(s) may then process the input data and, based at least on the processing, output data representing the document as updated. In some examples, the system(s) may then provide the user(s) with a user interface that includes the updated document for review.

In some examples, the system(s) may perform one or more processes to verify that updated documents are accurate. For a first example, the system(s) may receive input data representing user feedback associated with verifying an updated document, where the user feedback indicates whether the document was updated accurately. For instance, the user feedback may indicate that the document was updated accurately when the identified clause(s) was updated with the correct text or indicate that the document was not updated accurately when the identified clause(s) was not updated with the correct text. For a second example, the system(s) may input data (e.g., tokens, embeddings, etc.) associated with an updated document, one or more suggested clauses for which the document was updated, and/or a prompt into the model(s) (and/or another model). In some examples, the prompt may be associated with instructing the model(s) to perform a task, such as verifying that the updated document is accurate. The model(s) may then process the input data and, based at least on the processing, output data indicating whether the document was updated accurately.

In some examples, the systems and methods described herein may be used in a variety of technologies. For instance, the systems and methods described herein may be used to update legal templates—such as contracts, agreements, instructions, and/or the like—that are used by entities—such as corporations, companies, businesses, organizations, firms, and/or the like. For example, an entity may store a clause's library that includes various legal clauses—such as clauses related to laws, rulings, regulations, standards, compliances, and/or requirements—along with legal templates that use the clauses. As such, when one or more of the clauses are updated in the clause's library, the systems and methods described herein may automatically identify the templates and/or clauses within the templates that potentially need updating. Additionally, the systems and methods described herein may automatically update the templates. While some of the examples herein are described with respect to analyzing legal documents, in other examples, similar processes may be performed with regard to any other type of document, such as marketing documents, business documents, investment documents, real estate documents, scripts, etc.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice - such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure.

For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

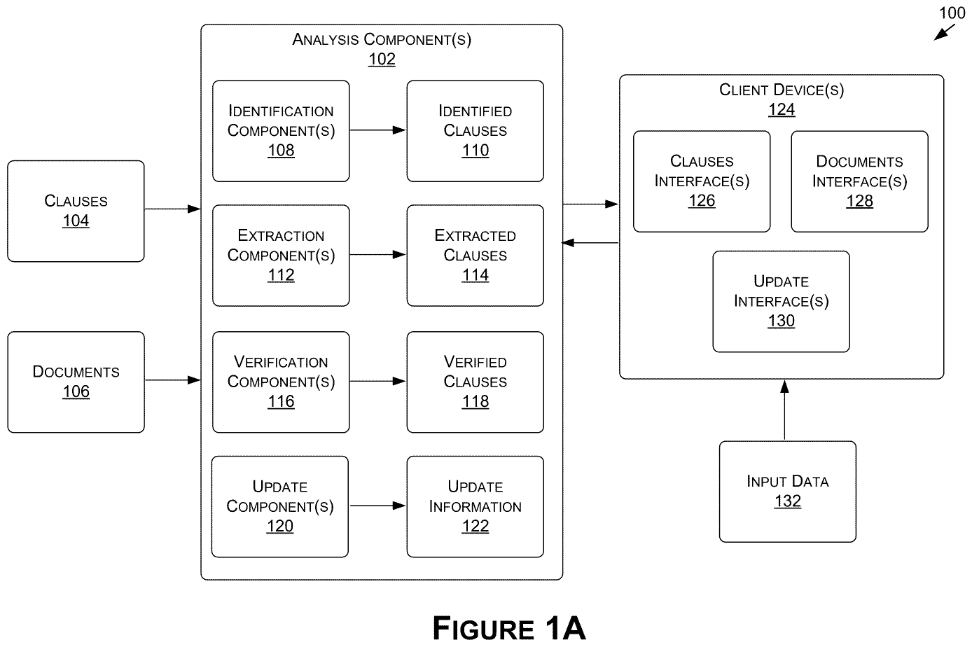

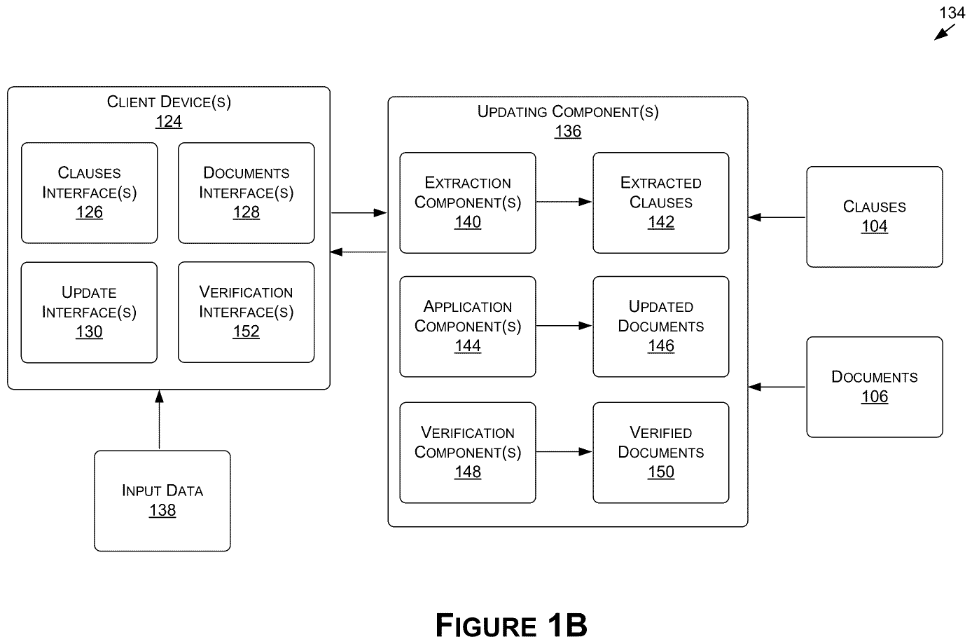

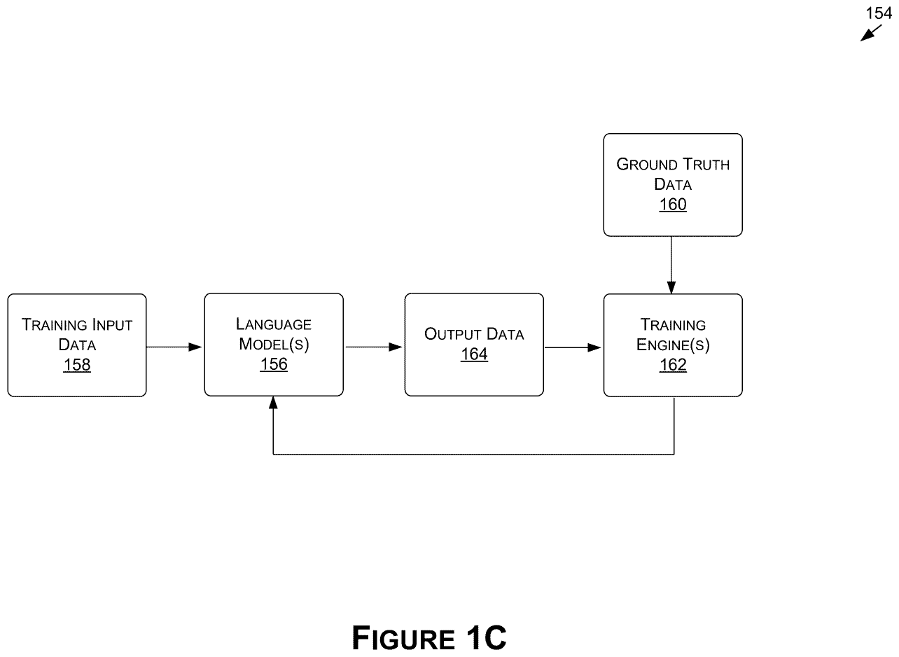

With reference to FIG. 1A illustrates an example of a process 100 for analyzing documents to identify and provide information associated with potential clause updates, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include one or more analysis components 102 receiving clauses 104 and documents 106 from one or more sources. As described herein, a clause 104 may include text—such as letters, numbers, words, sentences, paragraphs, symbols, punctation, and/or any other type of text. For examples, legal clauses 104 may include text describing laws, rulings, regulations, standards, compliances, requirements, and/or any other type of legal field. Additionally, the clauses 104 may be included as part of a clause's library that stores various clauses associated with an entity—such a corporation, a company, a business, an organization, a firm, and/or any other entity. In some examples, since clauses may be updated, the clauses 104 may include a current version of a clause 104 and/or one or more previous versions of a clause 104. Additionally, in some examples, the clauses 104 may include a main clause 104 and/or one or more subclauses 104 that are associated with the main clause. For example, a main clause 104 that is associated with legal compliances may include subclauses 104 that are associated with different types of legal compliances for different situations.

The documents 106 may include memos, contracts, agreements, licenses, instructions, manuals, lists, forms, charts, and/or any other type of document. Additionally, at least some of the documents 106 may include template documents 106, where a template document is created using one or more of the clauses 104 from a clause's library. For example, if a document 106 includes a legal contract—such as an employment contract, a licensing contract, and/or a sales contract—then the document 106 may include clauses 104 representing regulations and/or requirements that the parties must legally follow. In some examples, the documents 106 may include the current version of the clauses 104, such as when the documents 106 are initially created and/or updated. However, in some examples, at least some of the documents 106 may include previous version of the clauses 104 that need to be updated in order to maintain accurate and/or current information.

In some examples, the analysis component(s) 102 may be configured to perform chain-of-thought (CoT) analysis or prompting when analyzing the clauses 104 with respect to the documents 106. For example, the analysis component(s) 102 may prompt one or more models—such as one or more language models (and/or any other type of model)—to generate a step-by-step explanation, reasoning, and/or output associated with the analysis. For instance, and as shown, the analysis component(s) 102 may include multiple components, where each component of the analysis component(s) 102 is associated with a step in the processing. Additionally, and as described herein, the analysis component(s) 102 may be configured to output information describing how the analysis component(s) 102 (e.g., the model(s)) made one or more of the determinations described herein, where the information is then provided with the results to users. In some examples, this may help ensure the accuracy of the results of the analysis component(s) 102 when the results are reviewed by the user(s).

As such, the process 100 may then include the analysis component(s) 102 using various techniques to analyze the documents 106 in order to identify information—such as documents 106 that potentially need updating, clauses within the documents 106 that potentially need updating, and/or suggestions for potentially updating the documents 106. For instance, and as shown, the analysis component(s) 102 may use one or more identification components 108 that are configured to process at least a portion of the clauses 104 with respect to at least a portion of the documents 106 to identify clauses 110 within the documents 106 that potentially need to be updated. As described herein, a clause 110 in a document 110 may potentially need to be updated based at least on the clause 110 including a previous version of a related clause 104, the clause 110 including text that differs from the related clause 104, and/or for any other reason. Additionally, the identification component(s) 108 may use various processing techniques to identify the clauses 110 within the documents 106.

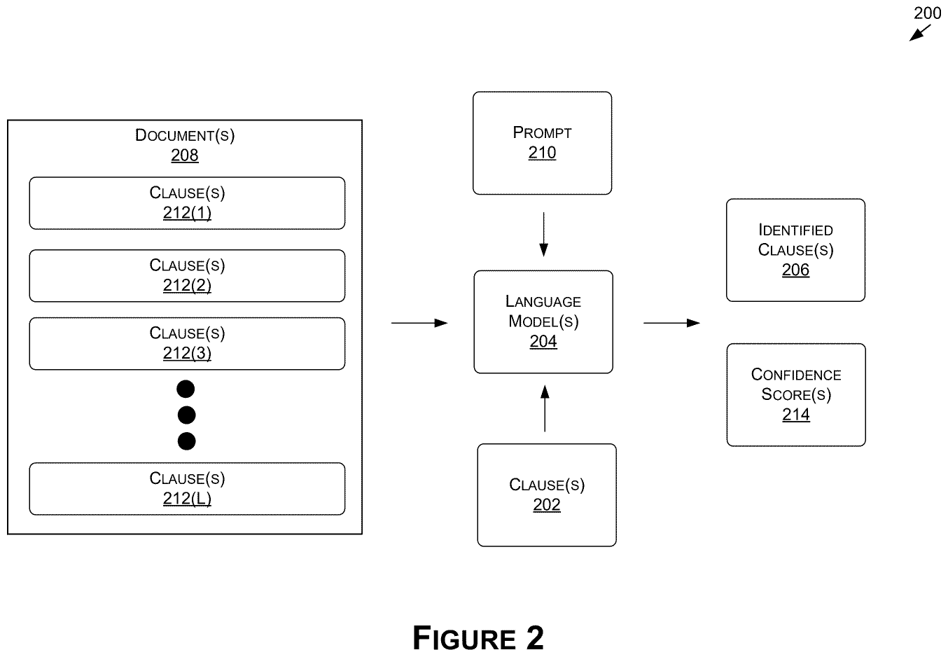

For instance, FIG. 2 illustrates an example of a process 200 for identifying clauses within documents that potentially need updating, in accordance with some embodiments of the present disclosure. As shown, and for a clause 202 (which may include, and/or be similar to, a clause 104), the identification component(s) 108 may use one or more language models 204 to identity one or more clauses 206 within one or more documents 208 that are related to the clause 202 and/or potentially need updating. For instance, the identification component(s) 108 may input, into the language model(s) 204, data (e.g., tokens, embeddings, etc.) representing at least the clause 202, the document(s) 208, and a prompt 210. As described herein, the prompt 210 may be associated with instructing the language model(s) 204 to perform a task, such as to identify one or more clauses 212(1)-(L) (also referred to singularly as “clause 212” or in plural as “clauses 212”) that are related to the clause 202 and/or potentially need to be updated.

For instance, the prompt 210 may provide one or more instructions for identifying the clauses 212 that are related to the clause 202. For example, the prompt 210 may instruct the language model(s) 204 to examine the document(s) 208 to determine if the document(s) 208 includes any clauses matching a given category, distinguish between definition clauses 212 that include defined terms (e.g., terms related to an industry, such as legal terms for legal documents, financial terms for financial documents, etc.) and non-definition clauses that do not include defined terms, compare the clause 202 with the clauses 212 in the document(s) 208 to identify most closely related matches in intent and text, use an identifier of the clause 202 to match identifiers of the clauses 212, return false if a document 208 does not contain a matching category, or return a confidence score 214 if a document 208 does contain a clause matching the category. However, in other examples, the prompt 210 may include any other instructions and/or tasks associated with causing the language model(s) 204 to identify the clause(s) 206.

Based at least on processing the input data, the language model(s) 204 may then generate and/or output data representing the identified clause(s) 206 that is related to the clause 202. In some examples, an identified clause 206 may be related to the clause 202 being analyzed based at least on the identified clause 206 including a previous version of the clause 202, a same version of the clause 202, and/or a modified version of the clause 202. In some examples, and as shown by the example of FIG. 2, the language model(s) 204 may be configured to generate and/or output additional data associated with the identified clause(s) 206, such as data representing one or more confidence scores 214. As described herein, a confidence score 214 associated with an identified clause 206 may indicate a likelihood that the identified clause 206 is related to the clause 202 and/or a likelihood that the identified clause 206 potentially needs to be updated.

In some examples, the identification component(s) 108 may then continue to perform similar processes to analyze one or more additional clauses 202 included in a clause's library. For instance, the identification component(s) 108 may perform similar processes to analyze each of the clause(s) 202 included in the clause's library and/or each of the updated clause(s) 202 included in the clause's library. This way, the identification component(s) 108 may automatically analyze the clause(s) 202 that may be important to identify each of the document(s) 208 that potentially need to be updated.

Referring back to the example of FIG. 1A, the analysis component(s) 102 may use one or more extraction components 112 that are configured to extract the identified clauses 110 from the documents 106, which may be represented by extracted clauses 114. For instance, an extracted clause 114 may include the actual text from a document 106 that is identified by the identification component(s) 108. As described herein, the extraction component(s) 112 may use various processing techniques to extract the clauses 114 from the documents 106.

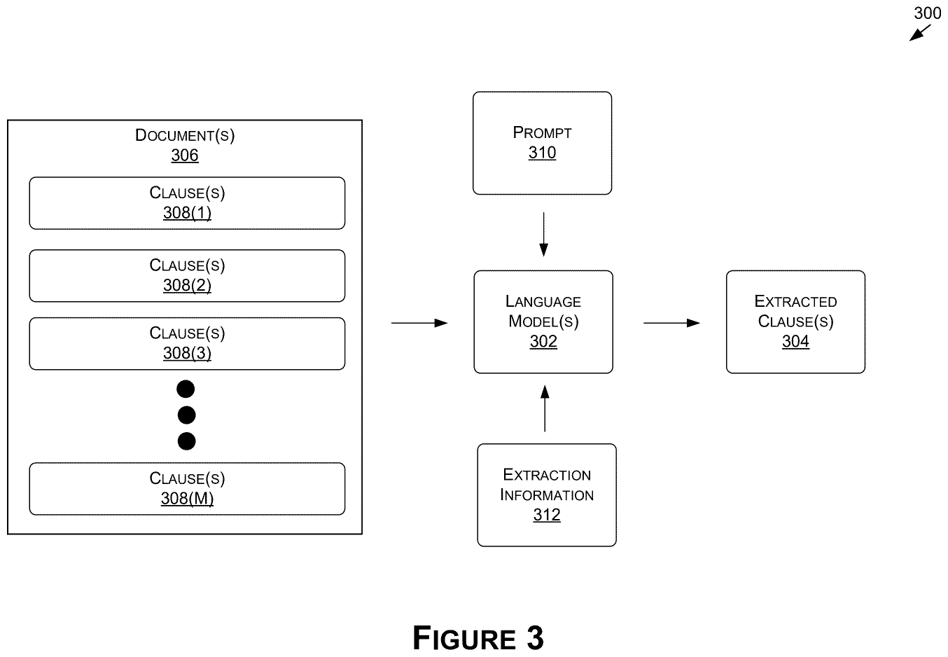

For instance, FIG. 3 illustrates an example of a process 300 for extracting clauses from documents, in accordance with some embodiments of the present disclosure. As shown, the extraction component(s) 112 may use one or more language models 302 (which may include, or be separate from, the language model(s) 204) to extract one or more clauses 304 from one or more document(s) 306 that are identified as included one or more clauses 308(1)-(M) (also referred to singularly as “clause 308” or in plural as “clauses 308”) that potentially need updating. For instance, the extraction component(s) 112 may input, into the language model(s) 302, data (e.g., tokens, embeddings, etc.) representing at least the document(s) 306, a prompt 310, and extraction information 312 for performing the extraction. As described herein, the prompt 310 may be associated with instructing the language model(s) 302 to perform a task, such as to extract one or more of the clauses 308 from the document(s) 306. Additionally, the extraction information 312 may identify the clause(s) 308 to extract, such as by identifying the document(s) 306, one or more locations within the document(s) 306 for which text corresponding to the clause(s) 308 is located, and/or any other information that the language model(s) 302 may use to extract the clause(s) 308. Based at least on processing the input data, the language model(s) 302 may then generate and/or output data representing the extracted clause(s) 304.

For instance, and in the examples of FIGS. 2 and 3, the language model(s) 204 may perform one or more of the processes described herein to identify that a first clause 212(1) from a document 208 is related to a clause 202. As described herein, the first clause 212(1) may be related to the clause 202 based at least on the first clause 212(1) including a previous version of the clause 202, a current version of the clause 202, and/or a modified version of the clause 202. As such, the language model(s) 302 may then perform one or more of the processes described herein to extract the first clause 212(1) (which may be represented by a first clause 308(1)) from the document 208 (which may be represented by a document 306), where the extracted first clause 212(1) may be represented by an extracted clause 304.

Referring back to the example of FIG. 1A, in some examples, the analysis component(s) 102 may use one or more verification components 116 to perform one or more verification processes with respect to the extracted clauses 114. As described herein, in some examples, the verification component(s) 116 may verify an extracted clause 114 based at least on the extracted clause 114 being related to a clause 104 and/or based at least on the extracted clause 114 potentially needing to be updated, where extracted clauses 114 that are verified may include verified clauses 118. Additionally, in some examples, the verification component(s) 116 may not verify an extracted clause 114 based at least on the extracted clause 114 not being related to a clause 104 and/or based at least on the extracted clause 114 not needing to be updated (e.g., the extracted clause 114 includes the current version of the clause 104). Additionally, the verification component(s) 116 may use various processing techniques to verify the extracted clauses 114 from the documents 106.

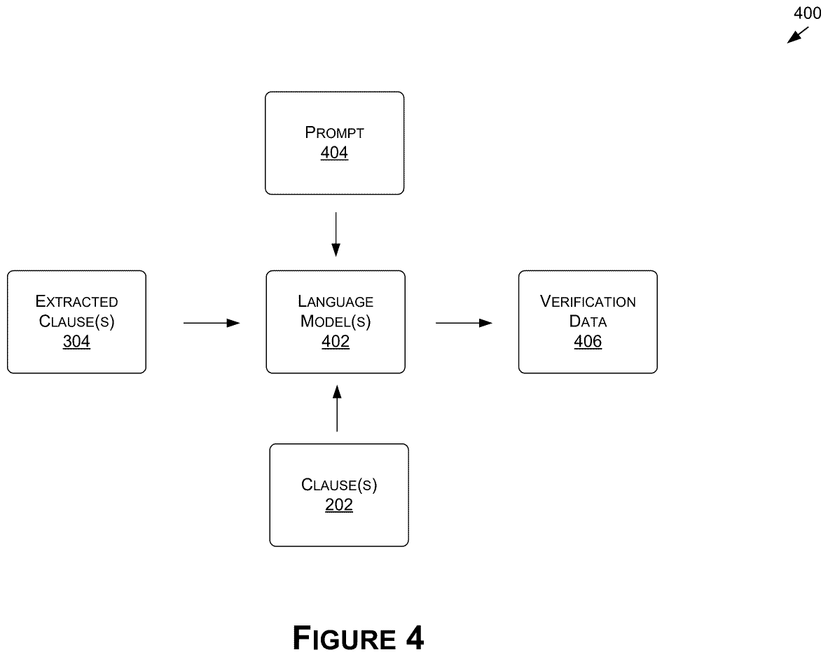

For instance, FIG. 4 illustrates an example of a process 400 for verifying clauses from documents that potentially need to be updated, in accordance with some embodiments of the present disclosure. As shown, the verification component(s) 116 may use one or more language models 402 (which may include, or be separate from, one or more of the language model(s) 204 and/or the language model(s) 302) to verify the extracted clause(s) 304 from the document(s) 306. For instance, and for an extracted clause 304, the verification component(s) 116 may input, into the language model(s) 402, data (e.g., tokens, embeddings, etc.) representing at least the extracted clause 304, a clause 202 that was used to identify the extracted clause 304, and a prompt 404. As described herein, the prompt 404 may be associated with instructing the language model(s) 402 to perform a task, such as to verify whether the extracted clause 304 is related to the clause 202 and/or verify whether the extracted clause 304 potentially needs updating based at least on the related clause 202. Based at least on processing the input data, the language model(s) 402 may then generate and/or output verification data 406 indicating whether the extracted clause 304 is verified.

For instance, if the extracted clause 304 is related to the clause 202 and/or potentially needs to be updated based at least on the clause 202, then the verification data 406 may indicate that the extracted clause 304 is verified. However, if the extracted clause 304 is not related to the clause 202 and/or does not need to be updated based at least on the clause 202, then the verification data 406 may indicate that the extracted clause 304 is not verified. In some examples, the verification data 406 may represent a first indicator (e.g., a first value, a first symbol, a first letter, etc.) when the extracted clause 304 is verified or a second indicator (e.g., a second value, a second symbol, a second letter, etc.) when the extracted clause 304 is not verified. In some examples, the verification data 406 may represent a confidence score indicating whether the extracted clause 304 is verified. In such examples, the extracted clause 304 may then be verified when the confidence score satisfies (e.g., is equal to or greater than) a threshold score (e.g., 80%, 90%, 95%, 99%, etc.). In any of the examples, the verification component(s) 116 may perform similar processes to verify one or more additional extracted clauses 304.

Referring back to the example of FIG. 1A, the analysis component(s) 102 may use one or more update components 120 to determine update information 122 associated with updating one or more of the verified clauses 118 (and/or one or more of the identified clauses 110). As described herein, in some examples, the update information 122 may include, but is not limited to, differences between the verified clauses 118 and the clauses 104, suggested updates to perform on the verified clauses 118 that are based at least on the clauses 104, text representing the verified clauses 118 as updated based on the suggested updates, and/or any other update information. For example, and for a verified clause 118 that is associated with a previous version of a clause 104, the update information 122 may indicate at least the differences between the versions of the clauses, suggested updates to make to the verified clause 118 in order for the verified clause 118 to be in the current version, and/or text representing the verified clause 118 updated with the suggested updates. As described herein, the update component(s) 120 may use various processing techniques to generate the update information 122.

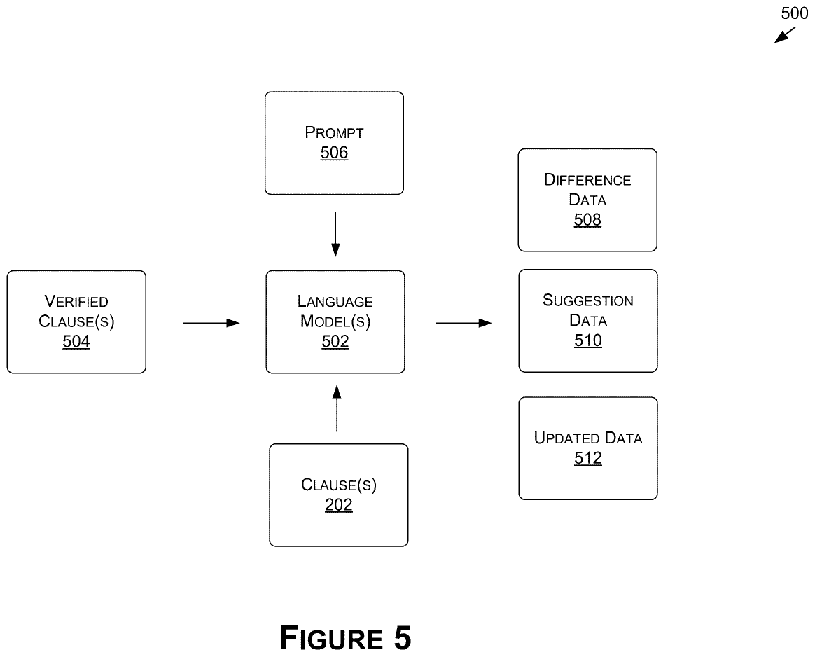

For instance, FIG. 5 illustrates an example of a process 500 for determining information for updating clauses included in documents, in accordance with some embodiments of the present disclosure. As shown, the update component(s) 120 may use one or more language models 502 (which may include, or be separate from, one or more of the language model(s) 204, the language model(s) 302, and/or the language model(s) 402) to determine update information associated with one or more verified clauses 504 (which may include, and/or be similar to, the verified clauses 118). For instance, and for a verified clause 504, the update component(s) 120 may input, into the language model(s) 502, data (e.g., tokens, embeddings, etc.) representing at least the verified clause 504 (and/or the document that includes the verified clause 504), a clause 202 that was used to identify the verified clause 504, and a prompt 506. As described herein, the prompt 506 may be associated with instructing the language model(s) 502 to perform a task, such as to determine the update information associated with the verified clause(s) 504. For instance, based at least on processing the input data, the language model(s) 502 may generate and/or output differences data 508, suggestion data 510, and/or update data 512.

The differences data 508 may represent one or more differences between the verified clause 504 as included in a document and the related clause 202. For instance, in some examples, the difference data 508 may represent one or more textual differences between the text of the verified clause 504 and the text of the related clause 202. As an example, if the verified clause 504 includes a previous version of the related clause 202, where the current version of the clause 202 was updated to include text describing new countries, then the difference data 508 may represent the text describing the new countries.

Additionally, the suggestion data 510 may represent one or more suggestions for updating the verified clause 504 to be similar to (e.g., match) the related clause 202. For instance, in some examples, the suggestion data 510 may represent text that should be deleted from the verified clause 504, text that should be changed within the verified clause 504, and/or text that should be added to the verified clause 504 in order for the verified clause 504 to match the related clause 202. For an example, and using the example above with the text describing the new countries, the suggestion data 510 may represent a suggestion to add the text describing the new countries to the verified clause 504. Furthermore, the update data 512 may represent the verified clause 504 as updated with the suggested updates. For an example, and again using the example above with the text describing the new countries, the update data 512 may represent the text of the verified clause 504 with additional text describing the new countries.

Referring back to the example of FIG. 1A, the process 100 may include the analysis component(s) 102, one or more client devices 124, and/or one or more additional components and/or computing devices generating one or more user interfaces associated with the analysis performed by the analysis component(s) 102. As shown, the user interface(s) may include at least a clauses interface 126 that presents one or more of the clauses 104 for which the analysis was performed and/or may additionally be performed, a documents interface 128 that presents one or more of the documents 106 for which the analysis was performed and/or may additionally be performed, and/or an update interface 130 that includes at least a portion of the update information 122. The client device(s) 124 may then present one or more of the user interfaces to one or more users such that the user(s) is able to determine details about the analysis.

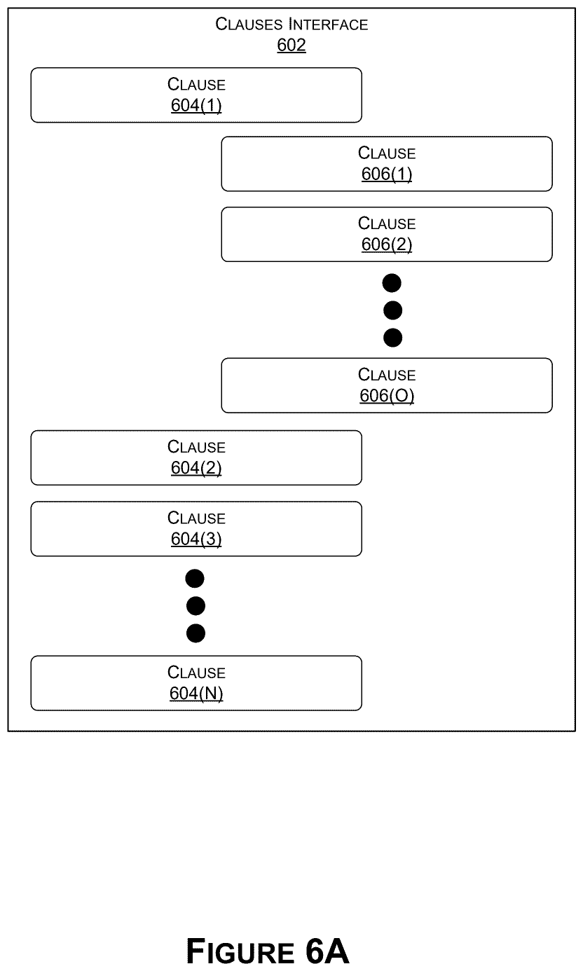

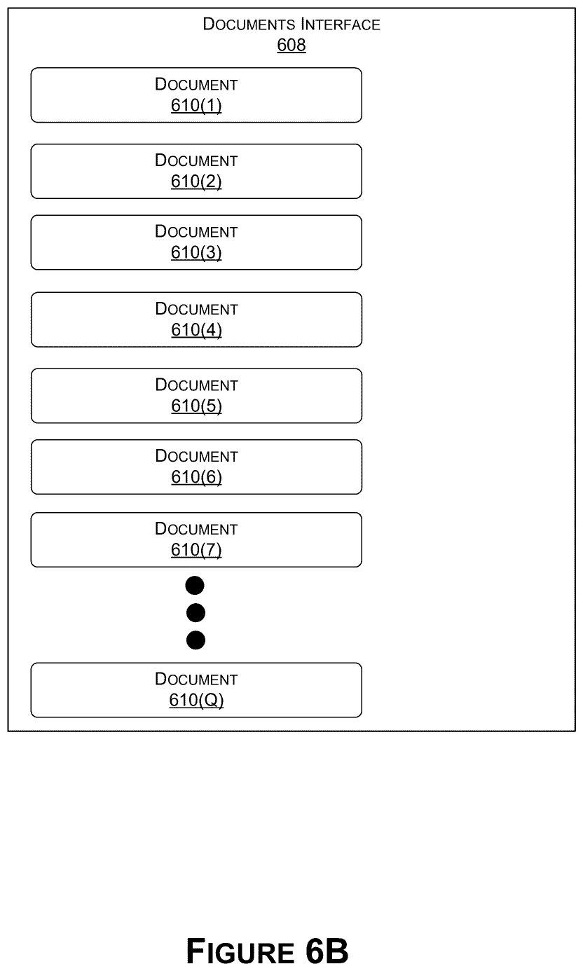

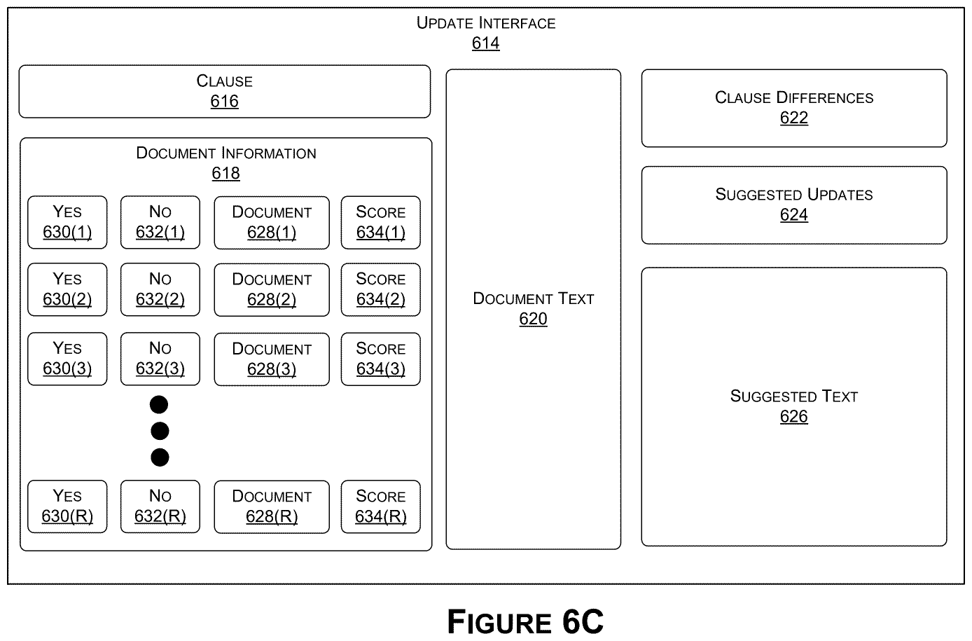

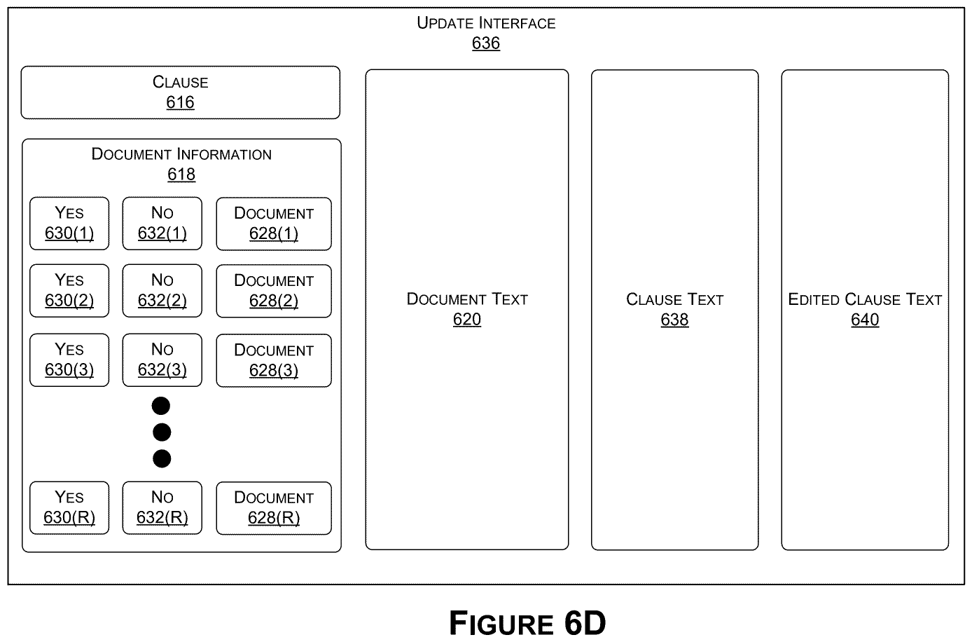

For instance, FIGS. 6A-6D illustrate examples of user interfaces that provide information associated with potential clause updates for documents, in accordance with some embodiments of the present disclosure. As shown by the example of FIG. 6A, a clauses interface 602 (which may include, and/or be similar to, a clauses interface 126) may present information related to clauses 604(1)-(N) (also referred to singularly as “clause 604” or in plural as “clauses 604”) and subclauses 606(1)-(O) (also referred to singularly as “subclause 606” or in plural as “subclauses 606”) that were analyzed by the analysis component(s) 102 and/or may potentially be analyzed by the analysis component(s) 102. In some examples, the information related to the clauses 604 and/or the subclauses 606 may include identifiers, such as names, titles, codes, references, addresses, numerical identifiers, alphabetic identifiers, alphanumeric identifiers, and/or any other type of identifier. Additionally, or alternatively, in some examples, the information related to the clauses 604 and/or the subclauses 606 may include at least a portion of the text from the clauses 604 and/or the subclauses 606.

The example of FIG. 6A illustrates that at least the first clause 604(1) may include the subclauses 606. For example, the first clause 604(1) may be associated with compliance regulations and the subclauses 606 may be associated with different types of compliance regulations that may be applied. However, in other examples, one or more of the other clauses 604(2)-(N) may include one or more subclauses.

As shown by the example of FIG. 6B, a documents interface 608 (which may include, and/or be similar to, a documents interface 128) may present information related to documents 610(1)-(Q) (which may also be referred to singularly as “document 610” or in plural as “documents 610”) that were analyzed by the analysis component(s) 102 and/or may potentially be analyzed by the analysis component(s) 102. In some examples, the information related to the documents 610 may include identifiers, such as names, titles, codes, references, addresses, numerical identifiers, alphabetic identifiers, alphanumeric identifiers, and/or any other type of identifier. Additionally, or alternatively, in some examples, the information related to the documents 610 may include at least a portion of the text from the documents 610.

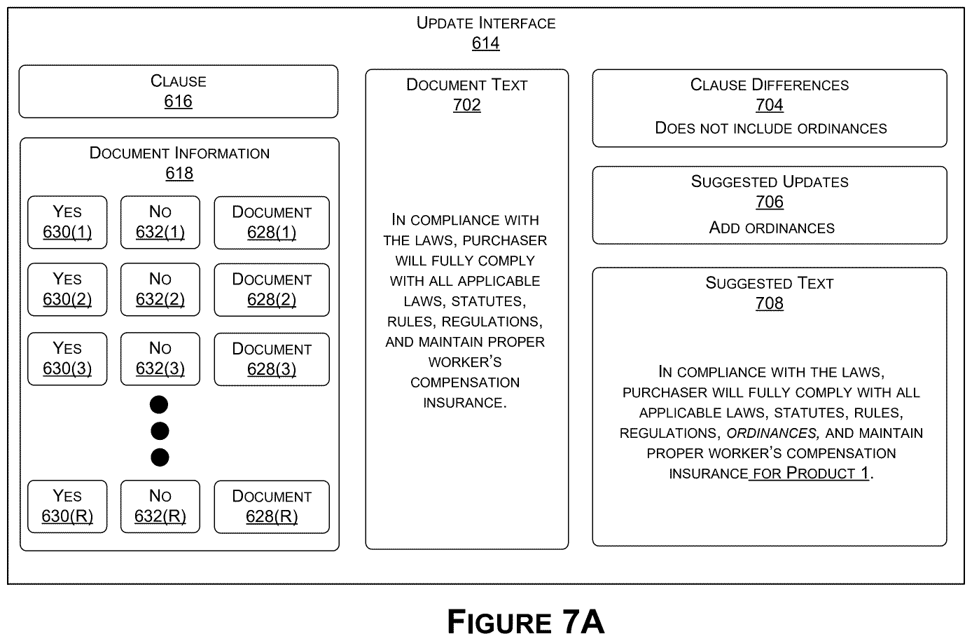

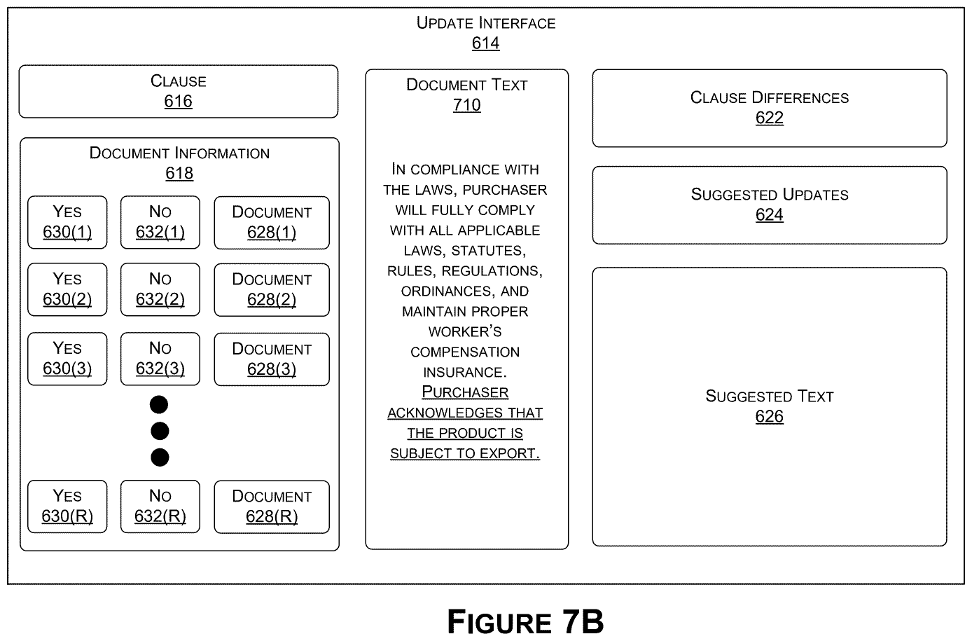

As shown by the example of FIG. 6C, an update interface 614 (which may include, and/or be similar to, an update interface 130) may include information related to the analysis performed by the analysis component(s) 102 (e.g., the update information 122). For instance, the update interface 614 may include at least information related to a clause 616 that was analyzed, documents 618 that were analyzed with respect to the clause 616, a portion of text 620 from a selected document that includes an identified clause, one or more differences 622 between the clause 616 and the identified clause from the document, one or more suggested updates 624 to make to the identified clause, and text 626 representing a suggested clause to use to update the identified clause within the document. For example, if a user selects a first document 628(1) from analyzed documents 628(1)-(R) (which may also be referred to singularly as “document 628” or in plural as “documents 628”), then the text 620 may include a portion of the first document 628(1) and the text 626 may include a suggested clause for updating the identified clause within the first document 628(1). An example the user interface 614 with corresponding text is shown with regard to FIGS. 7A-7B.

As further shown by the example of FIG. 6C, the update interface 614 may include interface elements 630(1)-(R) (which may also be referred to singularly as “interface element 630” or in plural as “interface elements 630”) associated with indicating that the clauses from the documents 628 are in fact related to the clause 616 and interface elements 632(1)-(R) (which may also be referred to singularly as “interface element 632” or in plural as “interface elements 632”) associated with indicating that the clauses from the documents 628 are not related to the clause 616. As described herein, an interface element 630 and 632 may include, but is not limited to, a button, a slider, a graphic, an image, and/or any other type of interactive element that is selectable.

The user interface 614 may further indicate confidence scores 634(1)-(R) (also referred to singularly as “confidence score 634” or in plural as “confidence scores 634”) associated with the documents 628. For instance, the confidence scores 634 may indicate likelihoods that the identified clauses from the documents 628 are related to the clause 616. For example, a high confidence score 634 may indicate a high probability that an identified clause from a document 628 is related to the clause 616 while a low confidence score 634 may indicate a low probability that an identified clause from a document 628 is related to the clause 616.

As shown by the example of FIG. 6D, an update interface 636 (which may include, and/or be similar to, an update interface 130) may include additional information related to the analysis performed by the analysis component(s) 102 (e.g., additional update information 122). For instance, the update interface 636 may include text 638 for the identified clause from the document 628 and text 640 of the clause 616. In some examples, the text 640 may further include one or more indicators that illustrate the differences between the text 638 for the identified clause from the document 628 and the text 638 of the clause 616. As described herein, an indicator may include, but is not limited to, a highlight, a font color, a font style, a comment, a pointer, and/or any other type of indicator that identifies the differences between the text 638 for the identified clause from the document 628 and the text 638 of the clause 616.

Referring back to the example of FIG. 1A, the process 100 may include the client device(s) 124 receiving input data 132 representing feedback associated with the analysis performed by the analysis component(s) 102. For example, such as when presenting the update interface(s) 130, the user(s) may provide feedback indicating whether the verified clauses 118 (and/or the identified clauses 110) from the documents 106 are related to the clauses 104. For instance, and with regard to the examples of FIGS. 6C-6D, the user data 132 may represent a selection of an interface element 630 when an identified clause from a document 628 is related to the clause 616 or a selection of an interface element 632 when an identified clause from a document 628 is not related to the clause 616. In some examples, and as described more herein, this feedback may be used to perform one or more processes, such as further training one or more of the language model(s).

For another example, such as again when presenting the update interface(s) 130, the user(s) may provide feedback associated with updating a suggested clause that is determined using the analysis component(s) 102. For instance, and with regard to the example of FIG. 6C, the user data 132 may represent feedback to delete a portion of the text 626 for the suggested clause, change a portion of the text 626 for the suggested clause, and/or add to the text 626 for the suggested clause. For instance, if the text 626 for the suggested clause includes the text from the clause 616, the user(s) may provide feedback to add additional text that is specific to an entity, such as the entity's name, location, and/or preferences.

For instance, FIG. 7A illustrates an example of receiving user feedback to update a suggested clause for a document, in accordance with some embodiments of the present disclosure. As shown, the user interface 614 may include text 702 of a clause from a document 628, where the clause is associated with a purchaser agreement from a seller. Additionally, the user interface 614 includes a difference 704 between the text 702 of the clause and the text of the clause 616, which is that “ordinance” is not included in the text 702, and a suggested update 706 for the text 702 of the clause, which is to add “ordinance” to the text 702. Furthermore, the user interface 614 may include text 708 representing a suggested clause for updating the document. In the example of FIG. 7A, the italicized portion of the text 708 may include the suggestion as determined using the analysis component(s) 102.

However, as additionally shown by the example of FIG. 7A, one or more users may have provided feedback to update the text 708 of the suggested clause. For example, the user(s) may provide feedback to add “for Product 1” to the suggested clause, which is indicated by the underlined portion of the text 708. As such, the analysis component(s) 102 may provide the initial suggested clause to the user(s) and then the user(s) may use the user interface 614 to further update the suggested clause to include a final clause for updating the document.

Referring back to the example of FIG. 1A, such as again when presenting the update interface(s) 130, the user(s) may provide feedback associated with updating verified clauses 118 (and/or identified clauses 110) from the documents 106 that were identified during the initial analysis. For instance, and as described herein, the update interface(s) 130 may present information that includes the text from a document 106 that is associated with a verified clause 118. However, if the analysis component(s) 102 does not identify the correct text, such as by including only a portion of the text of the clause or additional text that is not related to the clause, then the user(s) may provide the feedback indicating the actual text that should be associated with the clause.

For instance, FIG. 7B illustrates an example of receiving user feedback to update a verified clause within a document, in accordance with some embodiments of the present disclosure. As shown, the user interface 614 may include text 710 of a clause from a document 628, where the clause is again associated with a purchaser agreement from a seller. However, the text 710 that is initially identified by the analysis component(s) 102 as being associated with the clause may include the text 710 that is not underlined, which includes only a portion of the actual clause. As such, the user(s) may provide feedback indicating the rest of the text 710 of the clause, which is indicated by the underlined text. In some examples, the analysis component(s) 102 may then perform one or more processes using the feedback, such as again analyzing the clause using one or more of the processes described herein, but with using an entirety of the text 710 associated with the clause.

As described herein, in addition to providing information related to updating clauses of documents, in some examples, the documents may also be automatically updated such that the documents include the current clauses. For instance, FIG. 1B illustrates an example of a process 134 for updating clauses within documents, in accordance with some embodiments of the present disclosure.

As shown, the process 134 may include using one or more updating components 136 that are configured to update at least a portion of the verified clauses 118 (and/or the identified clauses 110) from the documents 106 using one or more techniques. In some examples, the updating component(s) 136 may update a document 106 in response to one or more events—such as receiving user feedback to update the document 106, receiving user feedback to update one or more clauses within the document 106, automatically based at least on the analysis component(s) 102 determining that the document 106 and/or the clause(s) potentially needs updated, at an elapse of a time interval since a last update to the document 106 and/or the clause(s), and/or any other event. For instance, and as shown, while displaying the update interface(s) 130 that includes a suggested clause for a document 106 (e.g., the text 708 for the suggested clause), the client device(s) 124 may receive and/or generate input data 138 representing a command to update the document 106 using the suggested clause.

As such, the updating component(s) 136 may use one or more extraction components 140 (which may include, and/or be similar to, the extraction component(s) 112) that are configured to extract clauses from documents 106 that are being updated, which may be represented by extracted clauses 142. In some examples, the extraction component(s) 140 may use any type of programming language when extracting clauses 142, such as Extensible Markup Language (XML) (and/or any other programming language). Additionally, the extraction component(s) 140 may use various processing techniques to extract the clauses 142 from the documents 106.

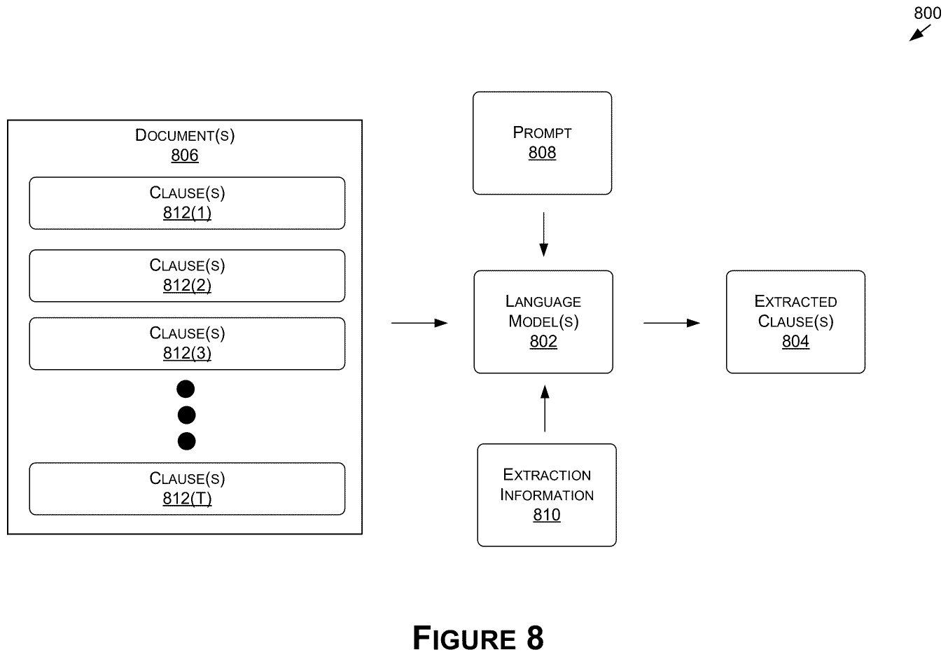

For instance, FIG. 8 illustrates an example of a process 800 for extracting clauses when updating documents, in accordance with some embodiments of the present disclosure. As shown, the extraction component(s) 140 may use one or more language models 802 (which may include, or be separate from, the language model(s) 204, the language model(s) 302, the language model(s) 402, and/or the language model(s) 502) to extract one or more clauses 804 from one or more documents 806 that are being updated. For instance, the extraction component(s) 140 may input, into the language model(s) 802, data (e.g., tokens, embeddings, etc.) representing at least the document(s) 806 to update, a prompt 808, and extraction information 810 for performing the extraction. As described herein, the prompt 808 may be associated with instructing the language model(s) 802 to perform a task, such as to extract at least some of clauses 812(1)-(T) (also referred to singularly as “clause 812” or in plural as “clauses 812”) from the document(s) 806. Additionally, the extraction information 810 may identify the clause(s) 812 to extract, such as by identifying the document(s) 806, one or more locations within the document(s) 806 for which the clause(s) 812 is located, and/or any other information that the language model(s) 802 may use to extract the clause(s) 812.

Based at least on processing the input data, the language model(s) 802 may then generate and/or output data representing the extracted clause(s) 804. For example, if the updating component(s) 136 is updating the clause 812(1) of a document 806, then the language model(s) 802 may generate and/or output data representing text associated with the clause 812(1), where the text includes an extracted clause 804. In some examples, the extraction component(s) 140 may perform such processes to extract a single clause 804 at an instance. However, in other examples, the extraction component(s) 140 may perform such processes to extract multiple clauses 804 at a single instance.

Referring back to the example of FIG. 1B, the updating component(s) 136 may use one or more application components 144 that are configured to apply updates to the documents 106 in order to generate updated documents 146. As described herein, the application component(s) 144 may use various techniques to update the documents 106. For a first example, the application component(s) 144 may update a document 106 by replacing one or more clauses of the document 106—such as the clause(s) 142 extracted by the extraction component(s) 140—with one or more updated clauses—such as the suggested clause(s) that was approved by the user(s) and/or automatically generated. For a second example, the application component(s) 144 may update a document 106 by revising one or more clauses of the document 106—such as the clause(s) 142 again extracted by the extraction component(s) 140—by deleting, changing, and/or adding text associated with the clause(s). While these are just a few example techniques for how the application component(s) 144 may apply the updates to the documents 106, in other examples, the application component(s) 144 may apply the updates using one more additional and/or alternative techniques.

In some examples, the application component(s) 144 may integrate current formats associated with the clauses when applying the updates. For instance, when updating a clause within a document 106, the application component(s) 144 may integrate similar text formatting—such as font style, font size, font bolding, font italicization, font underlining, font strikethroughs, font coloring, text capitalization, text highlighting, and/or any other type of formatting—to the updated clause within the updated document 146. For example, if the clause of the document 106 initially included a name of an entity using bold font, then the updated clause of the updated document 146 may also include the name of the entity using bold font. This way, when updating documents 106, the application component(s) 144 maintains a similar format such as for consistency and/or preference.

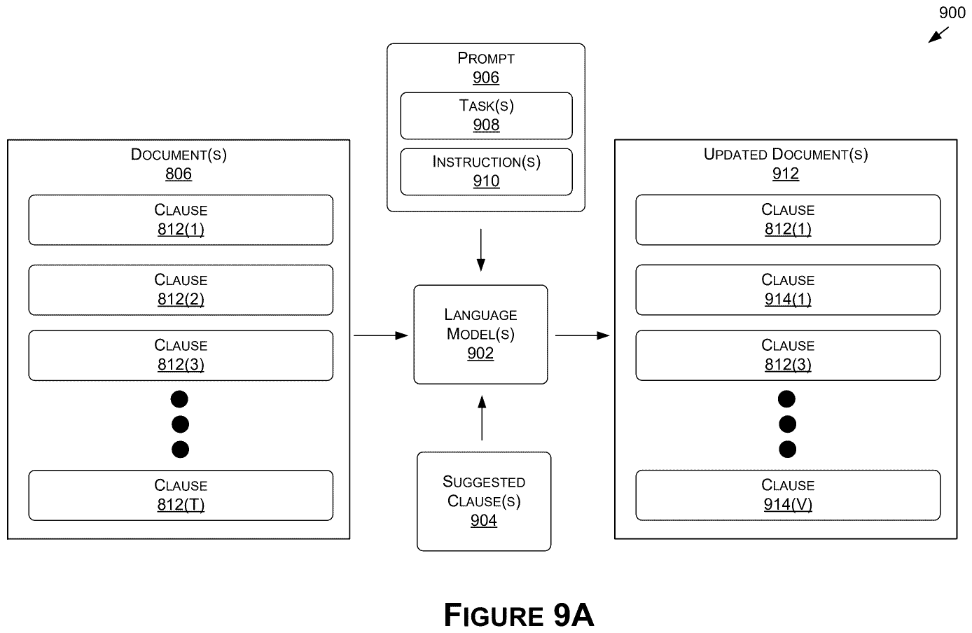

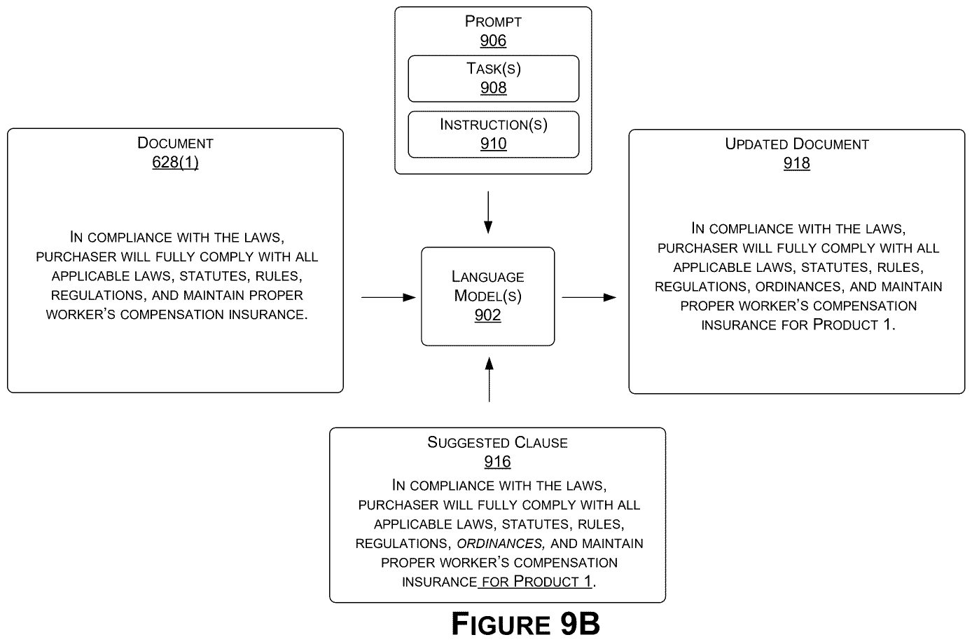

For instance, FIG. 9A illustrates an example of a process 900 for updating clauses of documents, in accordance with some embodiments of the present disclosure. As shown, the application component(s) 144 may use one or more language models 902 (which may include, or be separate from, the language model(s) 204, the language model(s) 302, the language model(s) 402, the language model(s) 502, and/or the language model(s) 802) to update one or more clauses 812 from the document(s) 806. For instance, the application component(s) 144 may input, into the language model(s) 902, data (e.g., tokens, embeddings, etc.) representing at least the document(s) 806 to update, one or more suggested clauses 904 to use to update the document(s) 806, and a prompt 906. As described herein, the prompt 906 may be associated with instructing the language model(s) 902 to perform a task, such as to update the document(s) 806 using the suggested clause(s) 904.

For instance, the prompt 906 may define one or more tasks 908, one or more instructions 910, and/or any other information for performing the updating. For example, a task 908 may include, but is not limited to, identifying differences between the suggested clause(s) 904 and one or more of the clauses 812 in the document(s) 806, updating the identified clause(s) 812 to more closely match the suggested clause(s) 904, providing explanations for updates that are performed, and/or any other task. Additionally, an instruction 910 may include, but is not limited to, making the minimum changes possible to achieve the alignment, ensuring that the updated clause(s) is sound and maintains integrity of the original document(s) 806, outputting a specific type of file (e.g., JavaScript Object Notation, etc.), maintaining formatting in the updated clause(s), and/or any other instruction. However, in other examples, the prompt 906 may include any other information associated with instructing the language model(s) 902 to update the document(s) 806.

Based at least on processing the input data, the language model(s) 902 may generate and/or output data representing one or more updated documents 912. As shown, at least a portion of the clauses 812 of the document(s) 806 may be updated when generating the updated document(s) 912, such as to include updated clauses 914(1)-(V) (which may also be referred to singularly as “updated clause 914” and/or in plural as “updated clauses 914”). For example, at least the clause 812(2) may be updated with the updated clause 914(1) and the clause 812(T) may be updated with the updated clause 914(V). In other words, the clauses 812(2) and 812(T) may have respectively included previous versions of the updated clauses 914(1) and 914(V).

Additionally, FIG. 9B illustrates an example of updating a clause within a document with a user suggested clause, in accordance with some embodiments of the present disclosure. As shown, the document 628(1) that includes text 702 associated with a clause may be updated. For instance, input data to the language model(s) 902 may be associated with the document 628(1), the prompt 906, and a suggested clause 916 that includes the text 708 determined by the analysis component(s) 102 and further updated by the user feedback. Based at least on processing the input data, the language model(s) 902 may generate and/or output data associated with an updated document 918 that at least replaces the text 702 associated with the initial clause with the text 708 of the suggested clause 916.

Referring back to the example of FIG. 1B, the updating component(s) 136 may use one or more verification components 148 to verify the updated documents 146, where the updated documents 146 that are verified include verified documents 150. As described herein, the verification component(s) 148 may use one or more techniques to perform the verification. For instance, in some examples, the verification component(s) 148 may verify an updated document 146 by determining that the updated document 146 may be accessed (e.g., opened) without any errors. For example, the verification component(s) 148 may verify that one or more updates to the document 106 did not cause errors such that the updated document 146 is no longer accessible. In some examples, the verification component(s) 148 may use one or more tools, such as one or more software development kit (SDK) tools, to perform the verification.

In some examples, the verification component(s) 148 may verify an updated document 146 based at least on feedback from a user. For instance, the verification component(s) 148 may provide the updated document 146 to the client device(s) 124. The client device(s) 124 may then provide a verification interface 152 that includes information for verifying the updated document 146. For instance, the information may include, but is not limited to, the document 106 before updating, the initial clause(s) of the document 106 before updating, the updated document 146, the updated clause(s) of the updated document 146, the differences between the initial clause(s) and the updated clause(s), the suggested updates associated with creating the updated clause(s), and/or any other information. The client device(s) 124 may then receive input data 138 indicating whether the updated document 146 is verified as being accurate.

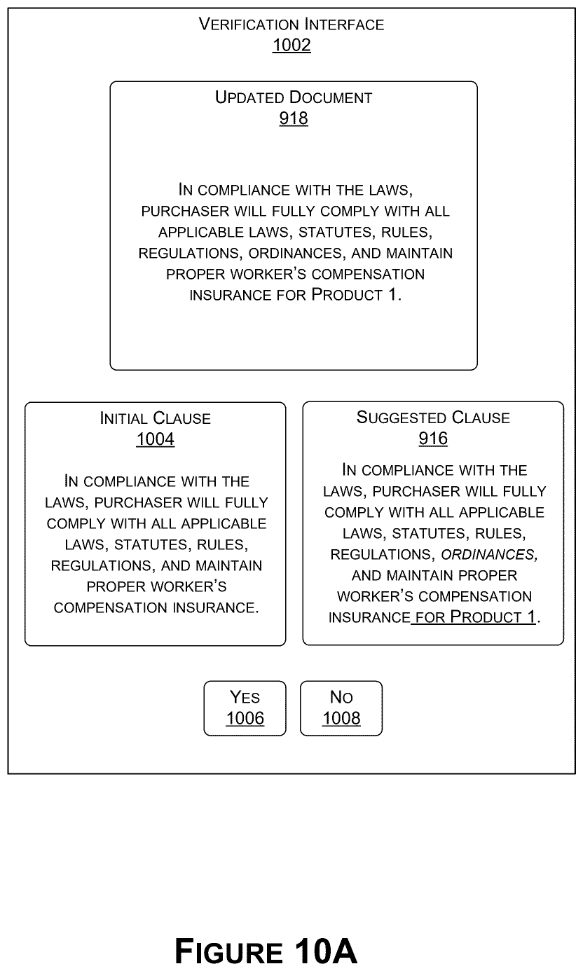

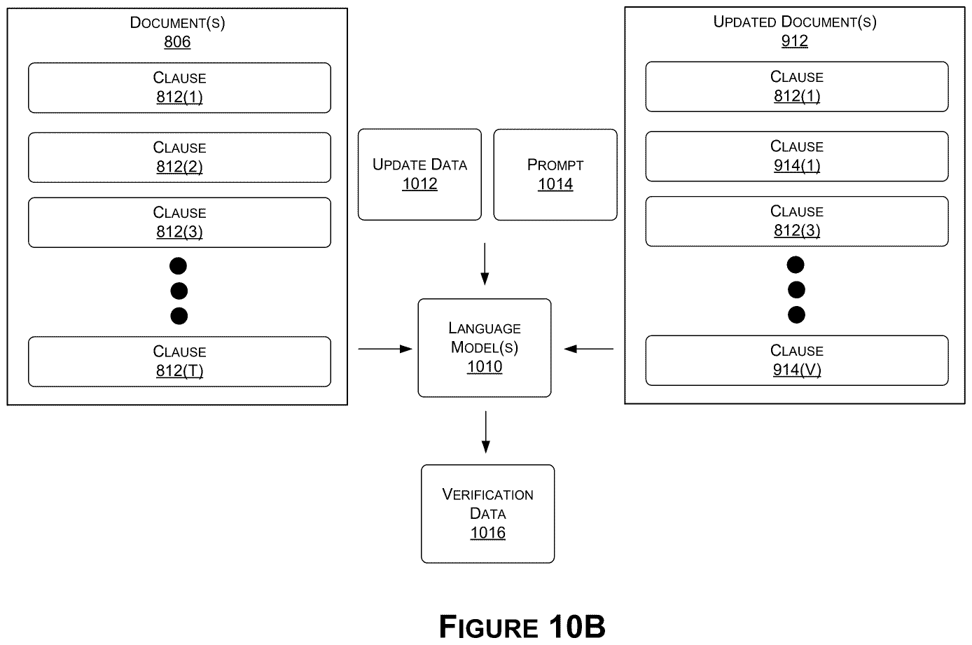

For instance, FIG. 10A illustrates an example of a user interface that provides information for verifying an updated document, in accordance with some embodiments of the present disclosure. As shown, a verification interface 1002 (which may include, and/or be similar to, a verification interface 152) may include at least an initial clause 1004 from the document 628(1) before the updating, the updated document 918, and the suggested clause 916 that was used to generate the updated document 918. However, in other examples, the verification interface 1002 may include additional information, such as one or more differences between the initial clause 1004 and the suggested clause 916 and/or one or more suggested updates determined by the analysis component(s) 102. The verification interface 1002 may further include an interface element 1006 associated with indicating that the updated document 918 is accurate and an interface element 1008 associated with indicating that the updated document 916 is inaccurate. As such, in the example of FIG. 10A, a user(s) may provide feedback selecting the interface element 1006 since the updated document 918 is accurate.

Referring back to the example of FIG. 1B, in some examples, the verification component(s) 148 may automatically verify updated documents 146. For instance, the verification component(s) 148 may automatically verify an updated document 114 based at least on the original document 106, the identified clause(s) within the document 106, one or more differences between the identified clause(s) and one or more related clauses 104, one or more suggested updates to the identified clause(s), one or more updated clauses, the updated document 114, and/or any other information. For example, the verification component(s) 148 may automatically verify the updated document 146 when the clause(s) was updated accurately or not verify the updated document 146 when the clause(s) was not updated accurately.

For instance, FIG. 10B illustrates an example of a process for verifying an updated document, in accordance with some embodiments of the present disclosure. As shown, the verification component(s) 148 may use one or more language models 1010 (which may include, or be separate from, the language model(s) 204, the language model(s) 302, the language model(s) 402, the language model(s) 502, the language model(s) 802, and/or the language model(s) 902) to verify the updated document(s) 912. For instance, the verification component(s) 148 may input, into the language model(s) 1010, data (e.g., tokens, embeddings, etc.) representing at least the document(s) 806, the updated document(s) 912, update data 1012, and a prompt 1014. As described herein, the update data 1012 may represent any information associated with updating the document(s) 806, such as differences between the clauses 812 and the updated clauses 914 and/or updates that occurred to the clauses 812 to create the updated clauses 914. Additionally, the prompt 1014 may be associated with instructing the language model(s) 1010 to perform a task, such as to verify the updated document(s) 912.

Based at least on processing the input data, the language model(s) 1010 may generate and/or output verification data 1016 indicating whether the updated document(s) 1010 is verified. In some examples, and for an updated document 912, the verification data 1014 may represent a first indicator (e.g., a first value, a first symbol, a first letter, etc.) that the updated document 912 is verified or a second indicator (e.g., a second value, a second symbol, a second letter, etc.) that the updated document 912 is not verified. In some examples, the verification data 1016 may represent a confidence score indicating whether the updated document 912 is verified. In such examples, the updated document 912 may then be verified when the confidence score satisfies (e.g., is equal to or greater than) a threshold score (e.g., 80%, 90%, 95%, 99%, etc.).

As described herein, in some examples, at least a portion of the user feedback may be used to perform one or more operations, such as to further training one or more of the language model(s). As such, FIG. 1C illustrates an example of a process 154 for training one or more language models 156 using user feedback, in accordance with some embodiments of the present disclosure. In the example of FIG. 5C, the language model(s) 156 may represent the language model(s) 204, the language model(s) 302, the language model(s) 402, the language model(s) 502, the language model(s) 802, the language model(s) 902, and/or the language model(s) 1010.

For instance, in some examples, the user feedback indicating whether identified clauses from documents 106 are related to clauses 104 and/or potentially need updating may be used to further train the language model(s) 156. For example, the user feedback may be used to further train the language model(s) 204 that identifies the clauses 110 from the documents 106, the language model(s) 302 that extracts the clauses 114 from the documents 106, and/or the language model(s) 402 that verifies the clauses 118 from the documents 106. In such examples, the documents 106, the clauses from the documents 106, and/or the clauses 104 may be used as training input data 158 while the user feedback may be used as ground truth data 160.

Additionally, or alternatively, in some examples, the user feedback indicting whether the documents 106 were updated accurately when generating the updated documents 146 may be used to further train the language model(s) 156. For example, the user feedback may be used to train the language model(s) 902 that updates the documents 106 to generate the updated documents 146. In such examples, the documents 106 and the suggested clauses for updating the documents 106 may be used as training input data 158 while the user feedback may be used as ground truth data 160.

In either of these examples, to train the language model(s) 156, one or more training engines 162 may use one or more loss functions that measure loss (e.g., error) in outputs 164 as compared to the ground truth data 160. Any type of loss function may be used, such as cross entropy loss, mean squared error, mean absolute error, mean bias error, and/or other loss function types. In some examples, different outputs 164 may have different loss functions. In such examples, the loss functions may be combined to form a total loss, and the total loss may be used to train (e.g., update the parameters of) the language model(s) 156. In any example, backward pass computations may be performed to recursively compute gradients of the loss function(s) with respect to training parameters. In some examples, weights and biases of the language model(s) 156 may be used to compute these gradients.

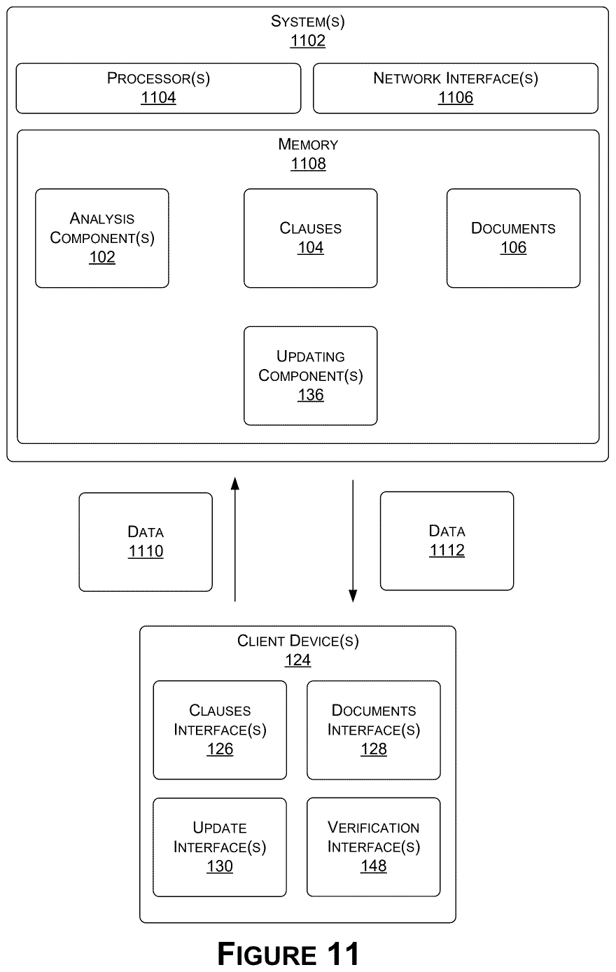

FIG. 11 illustrates an example of one or more systems 1102 that may perform at least a portion of the processes described herein, in accordance with some embodiments of the present disclosure. As shown, the system(s) 1102 may include one or more processors 1104 (which may include, and/or be similar to, a CPU(s) 1506 and/or a GPU(s) 1508), one or more communication interfaces 1106 (which may include, and/or be similar to, a communication interface 1510), and memory 1108 (which may include, and/or be similar to, memory 1504). Additionally, the memory 1108 may store the analysis component(s) 102, the clauses 104, the documents 106, and/or the updating component(s) 136. Furthermore, the processor(s) 1104 may execute the analysis component(s) 102 and/or the updating component(s) 136 to perform one or more of the processes described herein.

As shown, the system(s) 1102 may receive data 1110 from the client device(s) 124. As described herein, the data 1110 may represent the clauses 104, the documents 106, instructions to analyze the documents 106 using the clauses 104, feedback associated with the analysis, instructions to update one or more documents 106, feedback associated with the updating, and/or any other inputs. Additionally, the system(s) 1102 may send data 1112 back to the client device(s) 124. As described herein, the 1112 may represent information associated with the analysis, such as the identified clauses 110, the extracted clauses 114, the verified clauses 118, and/or the update information 122, one or more user interfaces, such as the clauses interface(s) 126, the documents interface(s) 128, the update interface(s) 130, and/or the verification interface(s) 152, information associated with the updating, such as the extracted clauses 142, the updated documents 146, and/or the verified documents, and/or any other information.

While the example of FIG. 11 illustrates the analysis component(s) 102 and the updating component(s) 136 as including software components, in other examples, the analysis component(s) 102, the updating component(s) 136, and/or any other component described herein may include a different type of processing component. For instance, a component may include, but is not limited to, software, hardware, a device, a system, a server, a data center, a processor, a module, a processing pipeline, a machine learning model, a neural network, a classifier, an algorithm, and/or any other type of processing component.

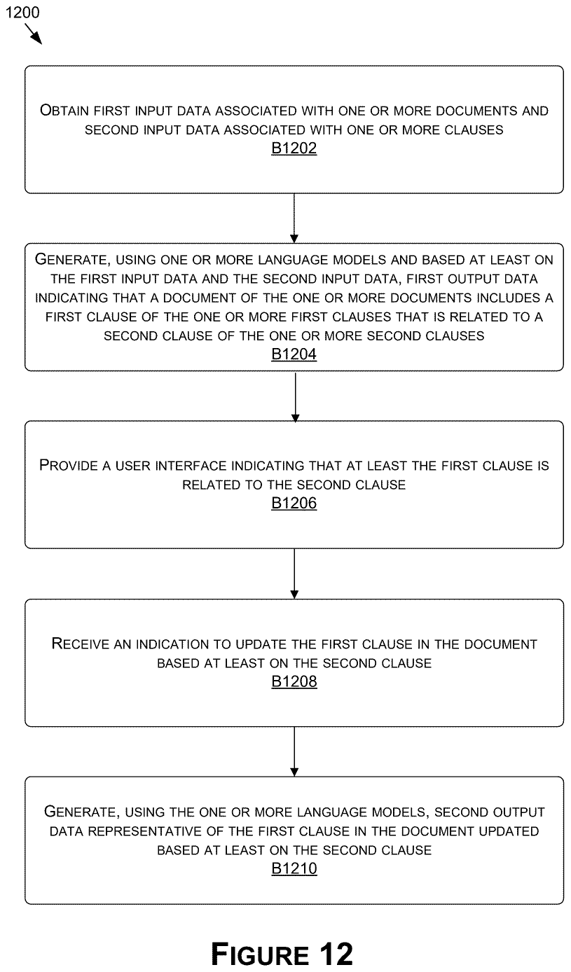

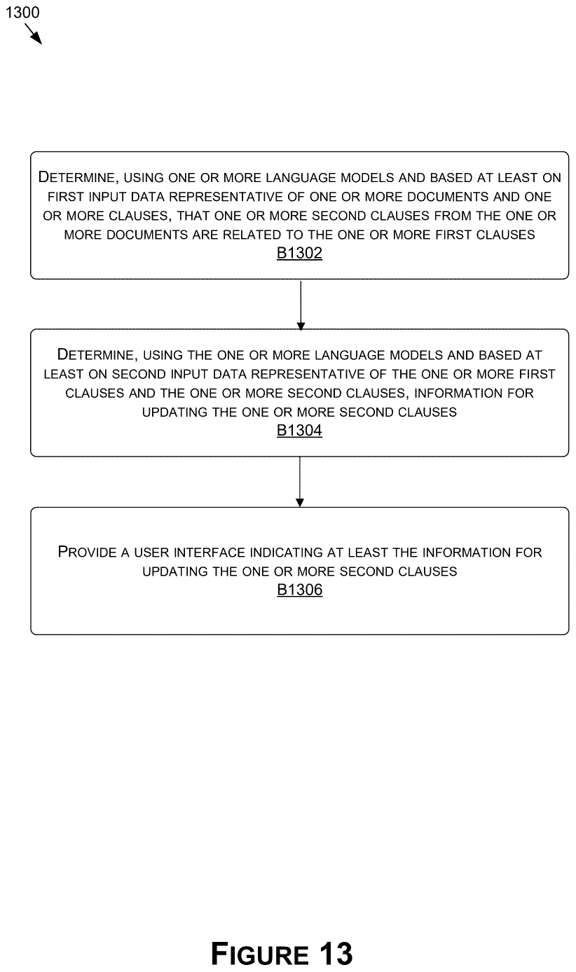

Now referring to FIGS. 12 and 13, each block of methods 1200 and 1330, described herein, comprises a computing process that may be performed using any combination of hardware, firmware, and/or software. For instance, various functions may be carried out by a processor executing instructions stored in memory. The methods 1200 and 1300 may also be embodied as computer-usable instructions stored on computer storage media. The methods 1200 and 1300 may be provided by a standalone application, a service or hosted service (standalone or in combination with another hosted service), or a plug-in to another product, to name a few. In addition, the methods 1200 and 1330 are described, by way of example, with respect to FIGS. 1A-1B. However, the methods 1200 and 1300 may additionally or alternatively be executed by any one system, or any combination of systems, including, but not limited to, those described herein.

FIG. 12 illustrates a flow diagram showing a method 1200 for identifying and updating a clause within a document, in accordance with some embodiments of the present disclosure. The method 1200, at block B1202, may include obtaining first input data associated with one or more documents that include one or more first clauses and second input data associated with one or more second clauses. For instance, the analysis component(s) 102 may receive the first input data representing one or more of the documents 106 and the second input data representing one or more of the clauses 104. As described herein, the document(s) 106 may include one or more templates that are created using at least a portion of the clauses 104. Additionally, the clause(s) 104 may be included in a clause's library, such as a clause's library associated with an entity.

The method 1200, at block B1204, may include generating, using one or more language models and based at least on the first input data and the second input data, first output data indicating that at least a document of the one or more documents includes a first clause of the one or more first clauses that is related to a second clause of the one or more second clauses. For instance, the analysis component(s) 102 (e.g., the identification component(s) 108) may use the language model(s) to process the first input data and the second input data. Based at least on the processing, the language model(s) may generate the first output data indicating that the first clause from the document 106 is related to the second clause 104. In some examples, the analysis component(s) 102 (e.g., the verification component(s) 116) may further use the language model(s) to verify that the first clause is related to the second clause.

The method 1200, at block B1206, may include providing a user interface indicating that at least the first clause is related to the second clause. For instance, the analysis component(s) 102 may generate the update interface(s) 130 indicating that the first clause is related to the second clause. The analysis component(s) 102 may then provide the update interface(s) 130, such as by sending data representing the update interface(s) 130 to the client device(s) 124. As described herein, in some examples, the update interface(s) 130 may include additional information, such as one or more differences between the clauses, one or more suggestions for updating the first clause, text representing the first clause updated based at least on the suggestion(s), and/or any other updating information.

The method 1200, at block B1208, may include receiving an indication to update the first clause in the document based at least on the second clause. For instance, the updating component(s) 136 may receive the indication to update the first clause based at least on the second clause. In some examples, the updating component(s) 136 may receive additional information, such as one or more additional textual updates associated with updating the first clause.

The method 1200, at block B1210, may include generating, using the one or more language models, second output data representative of the first clause in the document updated based at least on the second clause. For instance, the updating component(s) 136 (e.g., the application component(s) 144) may update the first clause within the document 106 based at least on the second clause. In some examples, the updating may include applying one or more changes to the first clause to cause the first clause to more closely match the second clause. In some examples, the updating component(s) 136 may use a suggested clause, as determined by the analysis component(s) 102, and/or the one or more additional textual updates to the suggested clause, as received from one or more users, to perform the update. Additionally, in some examples, the updating component(s) 136 (e.g., the verification component(s) 148) may verify the updated document 146.

FIG. 13 illustrates a flow diagram showing a method 1300 for analyzing documents to identify information for updating clauses in the documents, in accordance with some embodiments of the present disclosure. The method 1300, at block B1302, may include determining, using one or more language models and based at least on input data representative of one or more documents and one or more first clauses, that one or more second clauses from the one or more documents are related to the one or more first clauses. For instance, the analysis component(s) 102 (e.g., the identification component(s) 108) may use the language model(s) to process the first input data representing the document(s) 106 and the first clause(s) 104. Based at least on the processing, the language model(s) may determine that the second clause(s) from the document(s) 106 is related to the first clause(s) 104.

The method 1300, at block B1304, may include determining, using the one or more language models and based at least on second input data representative of the one or more first clauses and the one or more second clauses, information for updating the one or more second clauses. For instance, the analysis component(s) 102 (e.g., the update component(s) 120) may use the language model(s) to process the second input data representing the first clause(s) 104 and the second clause(s) from the document(s) 106. Based at least on the processing, the language model(s) may determine the update information 122 for updating the second clause(s) from the document(s) 106. As described herein, the update information 122 may include, but is not limited to, differences between the clauses, one or more suggestions for updating the second clause(s) from the document(s) 106, and/or text representing the second clause(s) from the document(s) 106 as updated with the suggestion(s).

The method 1300, at block B1306, may include providing a user interface indicating at least the information for updating the one or more second clauses. For instance, the analysis component(s) 102 may generate the update interface(s) 130 that includes at least the update information 122. The analysis component(s) 102 may then provide the update interface(s) 130, such as by sending data representing the update interface(s) 130 to the client device(s) 124.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs - such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

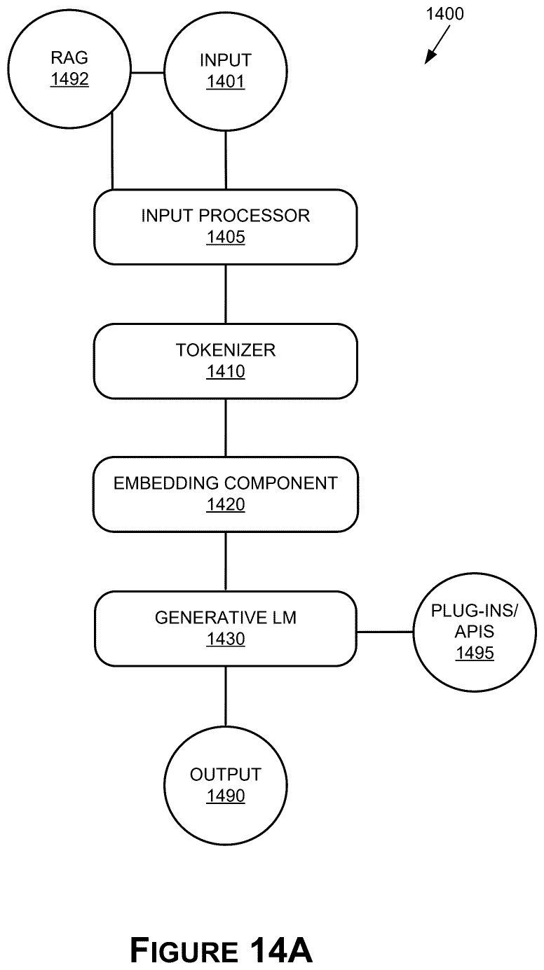

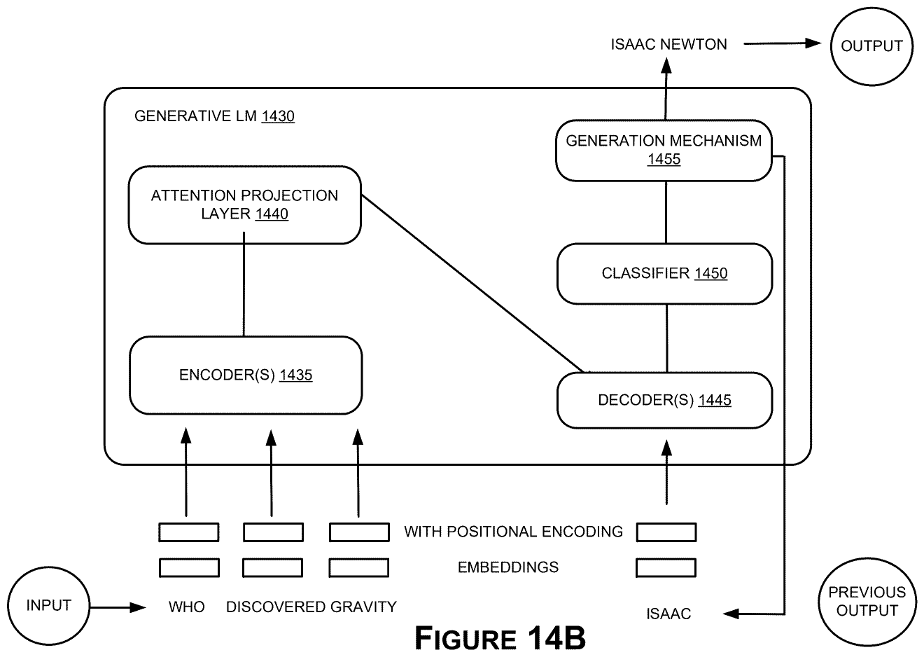

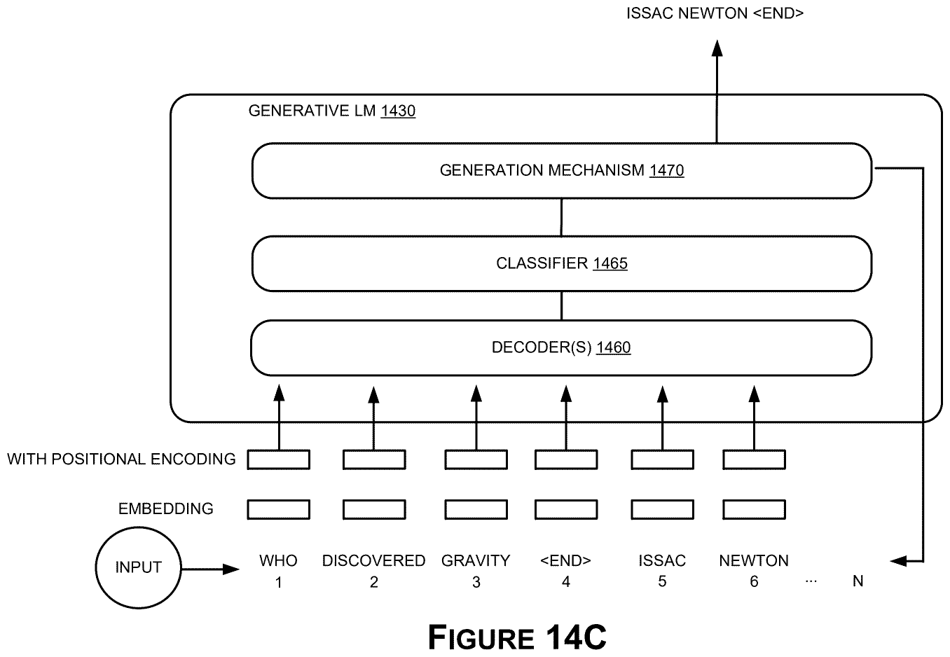

FIG. 14A is a block diagram of an example generative language model system 1400 suitable for use in implementing at least some embodiments of the present disclosure. In the example illustrated in FIG. 14A, the generative language model system 1400 includes a retrieval augmented generation (RAG) component 1492, an input processor 1405, a tokenizer 1410, an embedding component 1420, plug-ins/APIs 1495, and a generative language model (LM) 1430 (which may include an LLM, a VLM, a multi-modal LM, etc.).

At a high level, the input processor 1405 may receive an input 1401 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1430 (e.g., LLM/VLM/MMLM/etc.). In some embodiments, the input 1401 includes plain text in the form of one or more sentences, paragraphs, and/or documents. Additionally or alternatively, the input 1401 may include numerical sequences, precomputed embeddings (e.g., word or sentence embeddings), and/or structured data (e.g., in tabular formats, JSON, or XML). In some implementations in which the generative LM 1430 is capable of processing multi-modal inputs, the input 1401 may combine text (or may omit text) with image data, audio data, video data, design data, USD data, and/or other types of input data, such as but not limited to those described herein. Taking raw input text as an example, the input processor 1405 may prepare raw input text in various ways. For example, the input processor 1405 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1405 may remove stopwords to reduce noise and focus the generative LM 1430 on more meaningful content. The input processor 1405 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1492 (which may include one or more RAG models, and/or may be performed using the generative LM 1430 itself) may be used to retrieve additional information to be used as part of the input 1401 or prompt. RAG may be used to enhance the input to the LLM/VLM/MMLM/etc. with external knowledge, so that answers to specific questions or queries or requests are more relevant—such as in a case where specific knowledge is required. The RAG component 1492 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1401 may be generated using the query or input to the model (e.g., a question, a request, etc.) in addition to data retrieved using the RAG component 1492. In some embodiments, the input processor 1405 may analyze the input 1401 and communicate with the RAG component 1492 (or the RAG component 1492 may be part of the input processor 1405, in embodiments) in order to identify relevant text and/or other data to provide to the generative LM 1430 as additional context or sources of information from which to identify the response, answer, or output 1490, generally. For example, where the input indicates that the user is interested in a desired tire pressure for a particular make and model of vehicle, the RAG component 1492 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1492 may retrieve a prior stored conversation history—or at least a summary thereof—and include the prior conversation history along with the current ask/request as part of the input 1401 to the generative LM 1430.

The RAG component 1492 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1492 and the embeddings of the chunks along with the embeddings of the query may be compared to identify the most similar/related embeddings to the query, which may be supplied to the generative LM 1430 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1492 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1410 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1430 to understand morphological variations and handle out-of-vocabulary words more effectively. Character-based tokenization represents each character as a separate token, enabling the generative LM 1430 to process text at a fine-grained level. The choice of tokenization strategy may depend on factors such as the language being processed, the task at hand, and/or characteristics of the training dataset. As such, the tokenizer 1410 may convert the (e.g., processed) text into a structured format according to tokenization schema being implemented in the particular embodiment.

The embedding component 1420 may use any known embedding technique to transform discrete tokens into (e.g., dense, continuous vector) representations of semantic meaning. For example, the embedding component 1420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1401 includes image data/video data/etc., the input processor 1401 may resize the data to a standard size compatible with format of a corresponding input channel and/or may normalize pixel values to a common range (e.g., 0 to 1) to ensure a consistent representation, and the embedding component 1420 may encode the image data using any known technique (e.g., using one or more convolutional neural networks (CNNs) to extract visual features). In some implementations in which the input 1401 includes audio data, the input processor 1401 may resample an audio file to a consistent sampling rate for uniform processing, and the embedding component 1420 may use any known technique to extract and encode audio features—such as in the form of a spectrogram (e.g., a mel-spectrogram). In some implementations in which the input 1401 includes video data, the input processor 1401 may extract frames or apply resizing to extracted frames, and the embedding component 1420 may extract features such as optical flow embeddings or video embeddings and/or may encode temporal information or sequences of frames. In some implementations in which the input 1401 includes multi-modal data, the embedding component 1420 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM1430 and/or other components of the generative LM system 1400 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1420 may apply an encoded representation of the input 1401 to the generative LM 1430, and the generative LM 1430 may process the encoded representation of the input 1401 to generate an output 1490, which may include responsive text and/or other types of data.

As described herein, in some embodiments, the generative LM 1430 may be configured to access or use—or capable of accessing or using—plug-ins/APIs 1495 (which may include one or more plug-ins, application programming interfaces (APIs), databases, data stores, repositories, etc.). For example, for certain tasks or operations that the generative LM 1430 is not ideally suited for, the model may have instructions (e.g., as a result of training, and/or based on instructions in a given prompt, such as those retrieved using the RAG component 1492) to access one or more plug-ins/APIs 1495 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1495 to the plug-in/API 1495, the plug-in/API 1495 may process the information and return an answer to the generative LM 1430, and the generative LM 1430 may use the response to generate the output 1490. This process may be repeated—e.g., recursively—for any number of iterations and using any number of plug-ins/APIs 1495 until an output 1490 that addresses each ask/question/request/process/operation/etc. from the input 1401 can be generated. As such, the model(s) may not only rely on its own knowledge from training on a large dataset(s) and/or from data retrieved using the RAG component 1492, but also on the expertise or optimized nature of one or more external resources—such as the plug-ins/APIs 1495.

FIG. 14B is a block diagram of an example implementation in which the generative LM 1430 includes a transformer encoder-decoder. For example, assume input text such as “Who discovered gravity” is tokenized (e.g., by the tokenizer 1410 of FIG. 14A) into tokens such as words, and each token is encoded (e.g., by the embedding component 1420 of FIG. 914A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1435 of the generative LM 1430.

In an example implementation, the encoder(s) 1435 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1440 may convert the context vector into attention vectors (keys and values) for the decoder(s) 1445.

In an example implementation, the decoder(s) 1445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1435, in an example transformer architecture, each token (e.g., word) flows through a separate path in the decoder(s) 1445. During a first pass, the decoder(s) 1445, a classifier 1450, and a generation mechanism 1455 may generate a first token, and the generation mechanism 1455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1435, except that it creates its queries from the layer below it and takes the keys and values (e.g., matrix) from the output of the encoder(s) 1435.

As such, the decoder(s) 1445 may output some decoded (e.g., vector) representation of the input being applied during a particular pass. The classifier 1450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1455 may select or sample a word or token based on a corresponding predicted probability (e.g., select the word with the highest predicted probability) and append it to the output from a previous pass, generating each word or token sequentially. The generation mechanism 1455 may repeat the process, triggering successive decoder inputs and corresponding predictions until selecting or sampling a symbol or token that represents the end of the response, at which point, the generation mechanism 1455 may output the generated response.

FIG. 14C is a block diagram of an example implementation in which the generative LM 1430 includes a decoder-only transformer architecture. For example, the decoder(s) 1460 of FIG. 14C may operate similarly as the decoder(s) 1445 of FIG. 14B except each of the decoder(s) 1460 of FIG. 14C omits the encoder-decoder self-attention layer (since there is no encoder in this implementation). As such, the decoder(s) 1460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1460. As with the decoder(s) 1445 of FIG. 14B, each token (e.g., word) may flow through a separate path in the decoder(s) 1460, and the decoder(s) 1460, a classifier 1465, and a generation mechanism 1470 may use auto-regression to sequentially generate one token at a time until predicting a symbol or token that represents the end of the response. The classifier 1465 and the generation mechanism 1470 may operate similarly as the classifier 1450 and the generation mechanism 1455 of FIG. 14B, with the generation mechanism 1470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

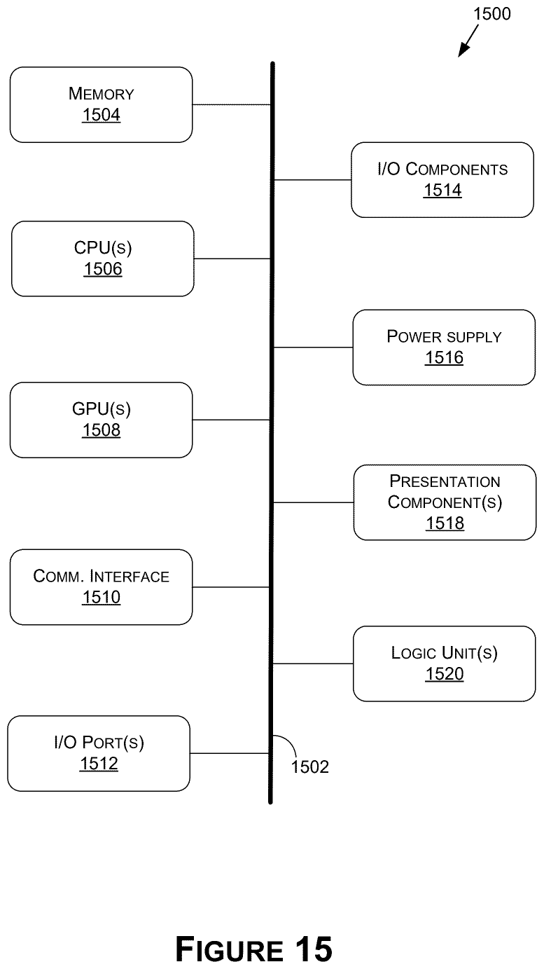

FIG. 15 is a block diagram of an example computing device(s) 1500 suitable for use in implementing some embodiments of the present disclosure. Computing device 1500 may include an interconnect system 1502 that directly or indirectly couples the following devices: memory 1504, one or more central processing units (CPUs) 1506, one or more graphics processing units (GPUs) 1508, a communication interface 1510, input/output (I/O) ports 1512, input/output components 1514, a power supply 1516, one or more presentation components 1518 (e.g., display(s)), and one or more logic units 1520. In at least one embodiment, the computing device(s) 1500 may comprise one or more virtual machines (VMs), and/or any of the components thereof may comprise virtual components (e.g., virtual hardware components). For non-limiting examples, one or more of the GPUs 1508 may comprise one or more vGPUs, one or more of the CPUs 1506 may comprise one or more vCPUs, and/or one or more of the logic units 1520 may comprise one or more virtual logic units. As such, a computing device(s) 1500 may include discrete components (e.g., a full GPU dedicated to the computing device 1500), virtual components (e.g., a portion of a GPU dedicated to the computing device 1500), or a combination thereof.

Although the various blocks of FIG. 15 are shown as connected via the interconnect system 1502 with lines, this is not intended to be limiting and is for clarity only. For example, in some embodiments, a presentation component 1518, such as a display device, may be considered an I/O component 1514 (e.g., if the display is a touch screen). As another example, the CPUs 1506 and/or GPUs 1508 may include memory (e.g., the memory 1504 may be representative of a storage device in addition to the memory of the GPUs 1508, the CPUs 1506, and/or other components). As such, the computing device of FIG. 15 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 15.

The interconnect system 1502 may represent one or more links or busses, such as an address bus, a data bus, a control bus, or a combination thereof. The interconnect system 1502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1506 may be directly connected to the memory 1504. Further, the CPU 1506 may be directly connected to the GPU 1508. Where there is direct, or point-to-point connection between components, the interconnect system 1502 may include a PCIe link to carry out the connection. In these examples, a PCI bus need not be included in the computing device 1500.

The memory 1504 may include any of a variety of computer-readable media. The computer-readable media may be any available media that may be accessed by the computing device 1500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1506 may be configured to execute at least some of the computer-readable instructions to control one or more components of the computing device 1500 to perform one or more of the methods and/or processes described herein. The CPU(s) 1506 may each include one or more cores (e.g., one, two, four, eight, twenty-eight, seventy-two, etc.) that are capable of handling a multitude of software threads simultaneously. The CPU(s) 1506 may include any type of processor, and may include different types of processors depending on the type of computing device 1500 implemented (e.g., processors with fewer cores for mobile devices and processors with more cores for servers). For example, depending on the type of computing device 1500, the processor may be an Advanced RISC Machines (ARM) processor implemented using Reduced Instruction Set Computing (RISC) or an x86 processor implemented using Complex Instruction Set Computing (CISC). The computing device 1500 may include one or more CPUs 1506 in addition to one or more microprocessors or supplementary co-processors, such as math co-processors.

In addition to or alternatively from the CPU(s) 1506, the GPU(s) 1508 may be configured to execute at least some of the computer-readable instructions to control one or more components of the computing device 1500 to perform one or more of the methods and/or processes described herein. One or more of the GPU(s) 1508 may be an integrated GPU (e.g., with one or more of the CPU(s) 1506 and/or one or more of the GPU(s) 1508 may be a discrete GPU. In embodiments, one or more of the GPU(s) 1508 may be a coprocessor of one or more of the CPU(s) 1506. The GPU(s) 1508 may be used by the computing device 1500 to render graphics (e.g., 3D graphics) or perform general purpose computations. For example, the GPU(s) 1508 may be used for General-Purpose computing on GPUs (GPGPU). The GPU(s) 1508 may include hundreds or thousands of cores that are capable of handling hundreds or thousands of software threads simultaneously. The GPU(s) 1508 may generate pixel data for output images in response to rendering commands (e.g., rendering commands from the CPU(s) 1506 received via a host interface). The GPU(s) 1508 may include graphics memory, such as display memory, for storing pixel data or any other suitable data, such as GPGPU data. The display memory may be included as part of the memory 1504. The GPU(s) 1508 may include two or more GPUs operating in parallel (e.g., via a link). The link may directly connect the GPUs (e.g., using NVLINK) or may connect the GPUs through a switch (e.g., using NVSwitch). When combined together, each GPU 1508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1506 and/or the GPU(s) 1508, the logic unit(s) 1520 may be configured to execute at least some of the computer-readable instructions to control one or more components of the computing device 1500 to perform one or more of the methods and/or processes described herein. In embodiments, the CPU(s) 1506, the GPU(s) 1508, and/or the logic unit(s) 1520 may discretely or jointly perform any combination of the methods, processes and/or portions thereof. One or more of the logic units 1520 may be part of and/or integrated in one or more of the CPU(s) 1506 and/or the GPU(s) 1508 and/or one or more of the logic units 1520 may be discrete components or otherwise external to the CPU(s) 1506 and/or the GPU(s) 1508. In embodiments, one or more of the logic units 1520 may be a coprocessor of one or more of the CPU(s) 1506 and/or one or more of the GPU(s) 1508.

Examples of the logic unit(s) 1520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1510 may include one or more receivers, transmitters, and/or transceivers that allow the computing device 1500 to communicate with other computing devices via an electronic communication network, included wired and/or wireless communications. The communication interface 1510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1520 and/or communication interface 1510 may include one or more data processing units (DPUs) to transmit data received over a network and/or through interconnect system 1502 directly to (e.g., a memory of) one or more GPU(s) 1508.

The I/O ports 1512 may allow the computing device 1500 to be logically coupled to other devices including the I/O components 1514, the presentation component(s) 1518, and/or other components, some of which may be built in to (e.g., integrated in) the computing device 1500. Illustrative I/O components 1514 include a microphone, mouse, keyboard, joystick, game pad, game controller, satellite dish, scanner, printer, wireless device, etc. The I/O components 1514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1500. The computing device 1500 may be include depth cameras, such as stereoscopic camera systems, infrared camera systems, RGB camera systems, touchscreen technology, and combinations of these, for gesture detection and recognition. Additionally, the computing device 1500 may include accelerometers or gyroscopes (e.g., as part of an inertia measurement unit (IMU)) that allow detection of motion. In some examples, the output of the accelerometers or gyroscopes may be used by the computing device 1500 to render immersive augmented reality or virtual reality.

The power supply 1516 may include a hard-wired power supply, a battery power supply, or a combination thereof. The power supply 1516 may provide power to the computing device 1500 to allow the components of the computing device 1500 to operate.

The presentation component(s) 1518 may include a display (e.g., a monitor, a touch screen, a television screen, a heads-up-display (HUD), other display types, or a combination thereof), speakers, and/or other presentation components. The presentation component(s) 1518 may receive data from other components (e.g., the GPU(s) 1508, the CPU(s) 1506, DPUs, etc.), and output the data (e.g., as an image, video, sound, etc.).

### Example Data Center

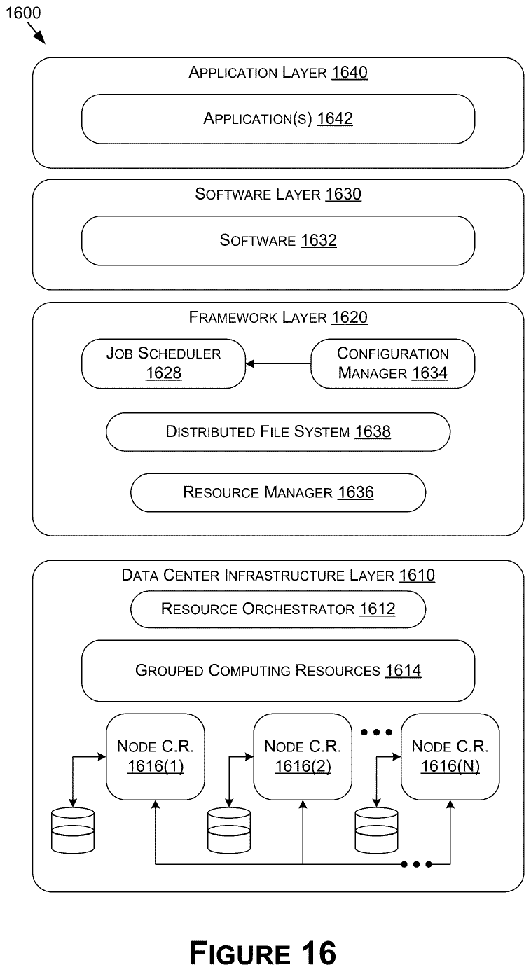

FIG. 16 illustrates an example data center 1600 that may be used in at least one embodiments of the present disclosure. The data center 1600 may include a data center infrastructure layer 1610, a framework layer 1620, a software layer 1630, and/or an application layer 1640.

As shown in FIG. 16, the data center infrastructure layer 1610 may include a resource orchestrator 1612, grouped computing resources 1614, and node computing resources (“node C.R.s”) 1616(1)-1616(N), where “N” represents any whole, positive integer. In at least one embodiment, node C.R.s 1616(1)-1616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1616(1)-1616(N) may correspond to a server having one or more of the above-mentioned computing resources. In addition, in some embodiments, the node C.R.s 1616(1)-16161(N) may include one or more virtual components, such as vGPUs, vCPUs, and/or the like, and/or one or more of the node C.R.s 1616(1)-1616(N) may correspond to a virtual machine (VM).

In at least one embodiment, grouped computing resources 1614 may include separate groupings of node C.R.s 1616 housed within one or more racks (not shown), or many racks housed in data centers at various geographical locations (also not shown). Separate groupings of node C.R.s 1616 within grouped computing resources 1614 may include grouped compute, network, memory or storage resources that may be configured or allocated to support one or more workloads. In at least one embodiment, several node C.R.s 1616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1612 may configure or otherwise control one or more node C.R.s 1616(1)-1616(N) and/or grouped computing resources 1614. In at least one embodiment, resource orchestrator 1612 may include a software design infrastructure (SDI) management entity for the data center 1600. The resource orchestrator 1612 may include hardware, software, or some combination thereof.

In at least one embodiment, as shown in FIG. 16, framework layer 1620 may include a job scheduler 1628, a configuration manager 1634, a resource manager 1636, and/or a distributed file system 1638. The framework layer 1620 may include a framework to support software 1632 of software layer 1630 and/or one or more application(s) 1642 of application layer 1640. The software 1632 or application(s) 1642 may respectively include web-based service software or applications, such as those provided by Amazon Web Services, Google Cloud and Microsoft Azure. The framework layer 1620 may be, but is not limited to, a type of free and open-source software web application framework such as Apache Spark™ (hereinafter “Spark”) that may use distributed file system 1638 for large-scale data processing (e.g., “big data”). In at least one embodiment, job scheduler 1628 may include a Spark driver to facilitate scheduling of workloads supported by various layers of data center 1600. The configuration manager 1634 may be capable of configuring different layers such as software layer 1630 and framework layer 1620 including Spark and distributed file system 1638 for supporting large-scale data processing. The resource manager 1636 may be capable of managing clustered or grouped computing resources mapped to or allocated for support of distributed file system 1638 and job scheduler 1628. In at least one embodiment, clustered or grouped computing resources may include grouped computing resource 1614 at data center infrastructure layer 1610. The resource manager 1636 may coordinate with resource orchestrator 1612 to manage these mapped or allocated computing resources.

In at least one embodiment, software 1632 included in software layer 1630 may include software used by at least portions of node C.R.s 1616(1)-1616(N), grouped computing resources 1614, and/or distributed file system 1638 of framework layer 1620. One or more types of software may include, but are not limited to, Internet web page search software, e-mail virus scan software, database software, and streaming video content software.

In at least one embodiment, application(s) 1642 included in application layer 1640 may include one or more types of applications used by at least portions of node C.R.s 1616(1)-1616(N), grouped computing resources 1614, and/or distributed file system 1638 of framework layer 1620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1634, resource manager 1636, and resource orchestrator 1612 may implement any number and type of self-modifying actions based on any amount and type of data acquired in any technically feasible fashion. Self-modifying actions may relieve a data center operator of data center 1600 from making possibly bad configuration decisions and possibly avoiding underutilized and/or poor performing portions of a data center.

The data center 1600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1600. In at least one embodiment, trained or deployed machine learning models corresponding to one or more neural networks may be used to infer or predict information using resources described above with respect to the data center 1600 by using weight parameters calculated through one or more training techniques, such as but not limited to those described herein.

In at least one embodiment, the data center 1600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1500 of FIG. 15—e.g., each device may include similar components, features, and/or functionality of the computing device(s) 1500. In addition, where backend devices (e.g., servers, NAS, etc.) are implemented, the backend devices may be included as part of a data center 1600, an example of which is described in more detail herein with respect to FIG. 16.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments - in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1500 described herein with respect to FIG. 15. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Clauses

A: A method comprising: obtaining first input data associated with one or more templates that include one or more first clauses and second input data associated with one or more second clauses; generating, using one or more language models and based at least on the first input data and the second input data, first output data indicating that at least a template of the one or more templates includes a first clause of the one or more first clauses that is related to a second clause of the one or more second clauses; providing a user interface indicating that at least the first clause is related to the second clause; receiving an indication to update the first clause in the template based at least on the second clause; and generating, using the one or more language models, second output data representative of the first clause in the template updated based at least on the second clause.

B: The method of paragraph A, wherein the first clause is related to the second clause based at least on at least one of: the first clause including a same clause as the second clause; the first clause including a previous version of the second clause; or the first clause including a modified version of the second clause.

C: The method of either paragraph A or paragraph B, further comprising: generating, using the one or more language models and based at least on third input data associated with at least the first clause and the second clause, third output data indicating a verification that the first clause is related to the second clause, wherein the user interface indicates that the first clause is related to the second clause based at least on the verification.

D: The method of any one of paragraphs A-C further comprising: generating, using the one or more language models and based at least on third input data associated with at least the first clause and the second clause, third output data indicating information for updating the first clause, the information including at least one of: one or more differences between the first clause and the second clause; one or more suggested updates to make to the first clause; or text representing the first clause as updated using the one or more suggested updates, wherein the user interface further indicates the information.

E: The method of any one of paragraphs A-D, further comprising: determining one or more text updates based at least on the first clause and the second clause; and updating, based at least on the one or more text updates, the first clause to generate a third clause, wherein: the user interface further indicates text associated with the third clause; the input data is representative of the indication to update the first clause using the third clause; and the one or more language models update the first clause based at least on the third clause.

F: The method of paragraph E, further comprising: receiving second input data representative of one or more second text updates associated with the first clause, wherein the updating the first clause to generate the third clause is further based at least on the one or more second text updates.

G: The method of any one of paragraphs A-F wherein: the first output data further indicates that a second template of the one or more templates includes a third clause of the one or more first clauses that is related to the second clause; and the user interface further indicates that the third clause is related to the second clause.

H: The method of any one of paragraphs A-G wherein: the first output data further indicates a probability that the first clause is related to the second clause; and the user interface further indicates the probability.

I: The method of any one of paragraphs A-H further comprising: providing, using at least one of the user interface or a second user interface, the template as updated based at least on the second clause; and receiving second input data indicating whether the template as updated is accurate.

J: A system comprising: one or more processors to: obtain first input data associated with one or more documents and second input data associated with one or more first clauses; determine, using one or more language models and based at least on the first input data and the second input data, that one or more second clauses from the one or more documents are related to the one or more first clauses; determine to update at least a second clause of the one or more second clauses based at least on a first clause of the one or more first clauses; and updating, using the one or more language models and based at least on third input data representative of the first clause, the second clause from a document of the one or more documents.

K: The system of paragraph J, wherein the one or more processors are further to: provide a user interface that indicates that at least the second clause from the document is related to the first clause, wherein the determination to update the second clause based at least on the first clause is based at least on receiving input data indicating to update the second clause based at least on the first clause.

L: The system of either paragraph J or paragraph K, wherein the one or more processors are further to verify, using the one or more language models and based at least on third input data representative of the one or more first clauses and the one or more second clauses, that the one or more second clauses are related to the one or more first clauses.

M: The system of any one of paragraphs J-L wherein the one or more processors are further to: determine, using the one or more language models and based at least on third input data associated with at least the first clause and the second clause, information for updating the second clause, the information including at least one of: one or more differences between the second clause and the first clause; one or more suggested updates to make to the second clause; or text representing the second clause as updated using the one or more suggested updates; and provide a user interface that includes at least the information.

N: The system of any one of paragraphs J-M wherein the one or more processors are further to: determine one or more text updates based at least on the first clause and the second clause; and update, based at least on the one or more text updates, the second clause to generate a third clause, wherein: the determination to update the second clause based at least on the first clause comprises determining to update the second clause using the third clause; and the one or more language models update the second clause using the third clause.

O: The system of paragraph N, wherein the one or more processors are further to: receive second input data representative of one or more second text updates associated with the second clause, wherein the updating the second clause to generate the third clause is further based at least on the one or more second text updates.

P: The system of any one of paragraphs J-O wherein the one or more processors are further to: determining one or more probabilities that the one or more second clauses are related to the one or more first clauses; and provide a user interface indicating the one or more probabilities that the one or more second clauses are related to the one or more first clauses.

Q: The system of any one of paragraphs J-P wherein the one or more processors are further to verify whether the document is updated accurately based at least on one or more of: receiving input data indicating whether the document is updated accurately; or determining, using the one or more language models and based at least on third input data associated with the document as updated, whether the document is updated accurately.

R: The system of any one of paragraphs J-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

S: One or more processors comprising: processing circuitry to update, using one or more language models, one or more clauses in one or more documents according to one or more changes to one or more updated clauses that correspond to the one or more clauses, wherein the one or more clauses are identified in the one or more documents based at least on the one or more language models processing a prior version of the one or more updated clauses and the one or more clauses and generating an output indicating a threshold similarity.

T: The one or more processors of paragraph S wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

What is claimed is:

1. A method comprising:
obtaining first input data associated with one or more templates that include one or more first clauses and second input data associated with one or more second clauses;
generating, using one or more language models and based at least on the first input data and the second input data, first output data indicating that at least a template of the one or more templates includes a first clause of the one or more first clauses that is related to a second clause of the one or more second clauses;
providing a user interface indicating that at least the first clause is related to the second clause;
receiving an indication to update the first clause in the template based at least on the second clause; and
generating, using the one or more language models, second output data representative of the first clause in the template updated based at least on the second clause.

2. The method of claim 1, wherein the first clause is related to the second clause based at least on at least one of:
the first clause including a same clause as the second clause;
the first clause including a previous version of the second clause; or
the first clause including a modified version of the second clause.

3. The method of claim 1, further comprising:
generating, using the one or more language models and based at least on third input data associated with at least the first clause and the second clause, third output data indicating a verification that the first clause is related to the second clause,
wherein the user interface indicates that the first clause is related to the second clause based at least on the verification.

4. The method of claim 1, further comprising:
generating, using the one or more language models and based at least on third input data associated with at least the first clause and the second clause, third output data indicating information for updating the first clause, the information including at least one of:
one or more differences between the first clause and the second clause;
one or more suggested updates to make to the first clause; or
text representing the first clause as updated using the one or more suggested updates,
wherein the user interface further indicates the information.

5. The method of claim 1, further comprising:
determining one or more text updates based at least on the first clause and the second clause; and
updating, based at least on the one or more text updates, the first clause to generate a third clause,
wherein:
the user interface further indicates text associated with the third clause;
the input data is representative of the indication to update the first clause using the third clause; and
the one or more language models update the first clause based at least on the third clause.

6. The method of claim 5, further comprising:
receiving second input data representative of one or more second text updates associated with the first clause,
wherein the updating the first clause to generate the third clause is further based at least on the one or more second text updates.

7. The method of claim 1, wherein:
the first output data further indicates that a second template of the one or more templates includes a third clause of the one or more first clauses that is related to the second clause; and
the user interface further indicates that the third clause is related to the second clause.

8. The method of claim 1, wherein:
the first output data further indicates a probability that the first clause is related to the second clause; and
the user interface further indicates the probability.

9. The method of claim 1, further comprising:
providing, using at least one of the user interface or a second user interface, the template as updated based at least on the second clause; and
receiving second input data indicating whether the template as updated is accurate.

10. A system comprising:
one or more processors to:
obtain first input data associated with one or more documents and second input data associated with one or more first clauses;
determine, using one or more language models and based at least on the first input data and the second input data, that one or more second clauses from the one or more documents are related to the one or more first clauses;
determine to update at least a second clause of the one or more second clauses based at least on a first clause of the one or more first clauses; and
updating, using the one or more language models and based at least on third input data representative of the first clause, the second clause from a document of the one or more documents.

11. The system of claim 10, wherein the one or more processors are further to:
provide a user interface that indicates that at least the second clause from the document is related to the first clause,
wherein the determination to update the second clause based at least on the first clause is based at least on receiving input data indicating to update the second clause based at least on the first clause.

12. The system of claim 10, wherein the one or more processors are further to verify, using the one or more language models and based at least on third input data representative of the one or more first clauses and the one or more second clauses, that the one or more second clauses are related to the one or more first clauses.

13. The system of claim 10, wherein the one or more processors are further to:
determine, using the one or more language models and based at least on third input data associated with at least the first clause and the second clause, information for updating the second clause, the information including at least one of:
one or more differences between the second clause and the first clause;
one or more suggested updates to make to the second clause; or
text representing the second clause as updated using the one or more suggested updates; and
provide a user interface that includes at least the information.

14. The system of claim 10, wherein the one or more processors are further to:
determine one or more text updates based at least on the first clause and the second clause; and
update, based at least on the one or more text updates, the second clause to generate a third clause,
wherein:
the determination to update the second clause based at least on the first clause comprises determining to update the second clause using the third clause; and
the one or more language models update the second clause using the third clause.

15. The system of claim 14, wherein the one or more processors are further to:
receive second input data representative of one or more second text updates associated with the second clause,
wherein the updating the second clause to generate the third clause is further based at least on the one or more second text updates.

16. The system of claim 10, wherein the one or more processors are further to:
determining one or more probabilities that the one or more second clauses are related to the one or more first clauses; and
provide a user interface indicating the one or more probabilities that the one or more second clauses are related to the one or more first clauses.

17. The system of claim 10, wherein the one or more processors are further to verify whether the document is updated accurately based at least on one or more of:
receiving input data indicating whether the document is updated accurately; or
determining, using the one or more language models and based at least on third input data associated with the document as updated, whether the document is updated accurately.

18. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

19. One or more processors comprising:
processing circuitry to update, using one or more language models, one or more clauses in one or more documents according to one or more changes to one or more updated clauses that correspond to the one or more clauses, wherein the one or more clauses are identified in the one or more documents based at least on the one or more language models processing a prior version of the one or more updated clauses and the one or more clauses and generating an output indicating a threshold similarity.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
